(19) United States
(12) Patent Application Publication
(10) Pub. No.: US 2010/0241535 A1
(43) Pub. Date: Sep. 23, 2010

(54) ACCOUNT ACTIVITY ALERT

(76) Inventors: Brad Nightengale, Redwood Shore, CA (US); Sharon Rowberry, San Mateo, CA (US); Pat Stan, Pacifica, CA (US)

Correspondence Address: Quarles & Brady LLP, TWO NORTH CENTRAL AVENUE, One Renaissance Square, PHOENIX, AZ, 85004-2391, US

(21) Appl. No.: 12/726,078

(22) Filed: Mar. 17, 2010

Related U.S. Application Data
(60) Provisional application No. 61/161,718, filed on Mar. 19, 2009.

(51) Int. Cl. G06Q 20/00; G06Q 10/00; G06Q 40/00; G06F 15/16

(52) U.S. Cl. 705/30; 705/44; 709/206

(57) ABSTRACT

An alert recipient receives an account alert after an account activity satisfies criteria of an alert rule. The account alert may be triggered by the usage of a consumer identifier with any of: an application for a new account, an account activation request, or an account usage. To illustrate, a fraudster may utilize the consumer identifier in an application to open a new account, to activate an issued prepaid account, or conduct a transaction on an activated issued prepaid account. Data from the account application, activation, or transaction may be sent to a host that compares the data against the criteria of an alert rule. If the criterion is satisfied, the account alert is sent to the account recipient. The account recipient may required to respond to the alert in order to permit the activity that is the subject of the account alert.

### RELATED APPLICATIONS

This application claims priority to, and the benefit of, U.S. Provisional Application Ser. No. 61/161,718, filed on Mar. 19, 2009, titled “Account Activity Alert,” with is incorporated herein by reference.

### FIELD

Implementations generally relate to processing of account activity in a payment processing system, and more particularly relate to an account alert sent to an alert recipient when there is an occurrence of account activity upon an account within a payment processing system that is associated with a consumer.

### BACKGROUND

Studies have shown that over 8.4 million US citizens have fallen victim to IDentity (ID) fraud, with losses amounting to approximately $US45 billion in 2007. In 2008, the number of victims increased to 9.9 million US citizens. ID fraud in financial transactions is also a significant problem outside the USA.

ID theft or fraud, and the fear thereof, has impacted the financial industry, reducing consumer confidence and trust in financial markets. For example, consumer behavioral spending patterns have been negatively affected by ID theft or fraud. According to Javelin® research, about 48% of ID theft victims avoid online shopping, about 28% switched to another form of payment, and about 19% switched financial institutions.

Success in mitigating the affects of fraud is highly correlated with early detection of ID theft and/or fraud. Over 71% of fraud incidents begin less than one week from the occurrence of the ID theft. However, consumers typically discover the ID theft/fraud months after its occurrence. For example, studies have shown that the consumer typical discovers the ID theft/fraud when the consumer is turned down for a credit application, or when the consumer is contacted by a debt collector. Often, the lag in ID theft/fraud detection for either new account or existing account fraud is over 160 days. This lag magnifies the impact of ID theft/fraud. For example, studies have shown that losses that are detected in the first 30 days from the ID theft/fraud average $US2,695, while losses that are detected more than three months after the ID theft/fraud average about $US8,192.

In response, some consumers are taking a more active role in protecting themselves against ID theft/fraud. For example, consumers may access their account statements on-line to monitor activity on their accounts, or they may pay for this monitoring service to be performed by an ID theft/fraud alert protection service instead of monitoring account activities themselves. For example, a consumer may set up a fraud alert with a credit bureau. Many credit bureaus within the United States offer credit monitoring services that can alert the consumer when the credit bureau detects suspicious activity upon the account(s) of the consumer that are being overseen by the credit bureau (e.g., credit card activity, mortgage loan activity). This service may be costly to the consumer and, in some cases, must to be renewed by the consumer every ninety days.

Credit bureau fraud alerts have some drawbacks. In particular, credit bureaus are unlikely to deliver a fraud alert immediately after an occurrence of suspicious activity on an account, or to deliver the fraud alert at a cost point acceptable to most consumers. In that credit bureaus have limited access to consumer transactional information upon most consumer accounts, fraud alerts are incompatible for mass marketplace or large scale use. Credit bureau alerts typically are sent only after an account has been opened and a fraudulent activity has been detected.

Given the foregoing, it can be seen that the unsolved problems of typical ID theft/fraud services include the long delay before sending a fraud alert following a suspected fraud activity on an account, sending the fraud alert only after an account has been opened, being incompatible with most consumer account transaction so as to have minimal market penetration, being priced beyond the reach of lower income consumers, and being of little or no use to consumers with little or no credit history. Accordingly, it would be an advance in the relevant art to solve the forgoing problems.

While the foregoing deals with credit relationships between debtor-consumers and their creditor institutions, many consumers do not have a credit relationship with a financial institution, such as a credit union or a bank. These consumers, who may be considered to be ‘underbanked’ or ‘unbanked’, appreciate the safety and convenience of using prepaid accounts issued to these consumers in order to conduct cashless transactions with merchants for the purchase of goods and services, as well as to make cash withdrawals.

Prepaid accounts are issued by different issuers. At the time that each prepaid account is issued by its issuer, the prepaid account is neither funded nor activated for use. Governmental authorities require, and issuers implement regulatory requirements such that, each issued, unactivated, and unfunded prepaid account cannot be activated for use until the account is associated with a ‘Globally Unique IDentifier’ (GUID). A GUID uniquely identifies a particular consumer from other consumers. Examples of a GUID include a tax identification number for a business that is a consumer, a social security number for a consumer, a passport identification number for a consumer, a government issued drivers license number for a consumer, a biological metric identifier for a consumer such as finger print data, retinal scan data, and other biometrics information, which may be combined with any of the foregoing in various combinations, so as to uniquely identifies a particular consumer from other consumers.

Once a prepaid account has been activated by association with a consumer's GUID, it can be funded. The activated, funded prepaid account can then be used by the consumer to conduct a transaction on the prepaid account with a merchant for the purchase of goods and services. The merchant, acting through its acquirer and a payment processing network (e.g.; the VisaNet® payment processing network), will be paid for the transaction from the funded, activated prepaid account by its issuer.

Activated and funded prepaid accounts can be gifted by a third party to a consumer. To do so, the third party provides the consumer's GUID and funding to an issuer. The third party can then receive a portable consumer payment device from the issuer, such as a prepaid account card. The card, which is representative of the activated and unfunded prepaid account can bear a magnetic strip encoding information about the prepaid account, or the card can be a ‘smart card’ that stores information about the prepaid account. Upon receipt by the third party, the card can be given to the consumer as gift. Examples of prepaid accounts that are activated and funded by third parties for the benefit of consumers include: (i) employers for employees; (ii) parents for their children; (iii) giftors for giftees; (iv) merchants giving awards or refunds to their customers; (v) governments giving entitlement benefits to its citizens; (vi) etc.

Although there are numerous benefits that consumers enjoy with prepaid accounts, these also have unsolved problems of typical ID theft and fraud for which it would be an advance in the relevant art to solve.

### SUMMARY

An alert recipient, such as a consumer, can receive an account alert in real time after an occurrence of activity upon the consumer's account (e.g., credit account or prepaid account). The activity may be, for example, a request to open the account (“account application”), a request to activate the account (“account activation”), a deposit in the account, or a withdrawal or transaction upon the account. The account alert may be, for example, in any electronic format such as an electronic mail (e-mail) addressed to the consumer's e-mail address, a prerecorded voice message sent to a telephone landline or cellular telephone of the consumer, or a Short Messaging Service (SMS) text message sent to the cellular telephone of the consumer. A call center, or other ID theft/fraud alert protection service, can send the account alert in any of the foregoing electronic formats to make contact with the consumer.

In some implementations, an account alert is transmitted to an alert recipient, such as a consumer, before the occurrence of a payment transaction upon an account. To illustrate, a fraudster may submit an account application that is fraudulently associated with the consumer. Such an association may be that the account is attempted to be opened by use of an identifier that is unique to the consumer. The account, for example, can be a unsecured credit account, a prepaid account, a mortgage loan account, etc.) Data about the account application is submitted to a host. The host evaluates the submitted data to determine if characteristics of the account application match pre-selected fraud criteria. If there is a match, then the submitted data is flagged as potentially fraudulent or deceptive. If the account application is determined to be potentially fraudulent or deceptive, then the account alert is sent to the alert recipient.

In another implementation, after an account has been opened without identifying a consumer, an account alert is transmitted to an alert recipient after the account is activated. The activation process for the account, typically for prepaid accounts, involves associating the account with a consumer. Such an association is made by use of an identifier that is unique to the consumer. The identifier, along with other data about the activation is sent to a host. The host evaluates the sent data to determine if characteristics of the application match pre-selected criteria such that it is flagged as potentially fraudulent or deceptive. If the activation is determined to be potentially fraudulent or deceptive, then the account alert is sent to the alert recipient, who in this implementation can be the consumer.

In yet another implementation, an account alert is transmitted to an alert recipient after a deposit is made into an account that is associated with a consumer. For example, data about the deposit to the account is sent to the host. The host evaluates the sent data to determine if characteristics of the deposit match pre-selected criteria such that it is flagged as potentially fraudulent or deceptive (e.g., money laundering). If the data is flagged, then the account alert is sent to the alert recipient, who in this implementation can be the consumer.

In still another implementation, an activation is accomplished for an issued prepaid account for which a Globally Unique IDentifier (GUID) for a consumer is offered to be associated. The GUID will be matched with an electronically stored GUID having associated therewith a plurality of logical addresses. The issued prepaid account will be activated only after an electronic response is received from each of the stored logical address to which an electronic request sent. Each received electronic response will include information corresponding to an approval of the activation of the issued prepaid account so as to be associated with the stored GUID.

In yet another implementation pertaining to an activated issued prepaid account to which a Globally Unique IDentifier (GUID) for a consumer is associated, a currency amount in excess of a predetermined threshold will be deposited into the prepaid account only after an electronic response is received from each of a plurality of stored logical addresses associated with the GUID to which an electronic request sent. Prior to sending each electronic request to each logical address, the GUID will be matched against electronically stored GUIDs each having associated therewith a plurality of logical addresses. Each received electronic response will include information corresponding to an approval of the deposit. The approval may be indicated, for instance, by containing the GUID.

In a still further another implementation pertaining to an activated issued prepaid account to which a Globally Unique IDentifier (GUID) for a consumer is associated, a transaction on the prepaid account will be attempted to be conducted at a location with a merchant for a purchase of an item. The transaction, however, will be permitted to be conducted only after an electronic response is received from each of a plurality of stored logical addresses associated with the GUID to which an electronic request sent. Prior to sending each electronic request to each logical address, the GUID will be matched against electronically stored GUIDs each having associated therewith a plurality of logical addresses. The matching stored GUID will have associated therewith one or more stored prohibited locations, merchants, and items against which data for the attempted transaction is matched. If there is a match of the transaction data against the stored prohibited transaction data, then the electronic request is sent to each logical address associated with the matching GUID. Each received electronic response will include information corresponding to an approval of the transaction. The approval may be indicated, for instance, by containing the GUID.

### BRIEF DESCRIPTION OF THE DRAWINGS

Implementations will become more apparent from the detailed description set forth below when taken in conjunction with the drawings, in which like elements bear like reference numerals.

FIG. 1 is a schematic illustrating an exemplary process flow, including transaction processing system(s), for transmitting an account alert to an alert recipient;

FIG. 2 is a schematic illustrating exemplary account alerts, rendered in electronic formats on exemplary computing apparatus, and pertaining to a transmitted account alert;

FIGS. 3-4 are schematics illustrating respective exemplary process flows for interactive account alerts between a host and an alert recipient;

FIG. 5 depicts a flowchart of an exemplary method for interactive account alert communications with an alert recipient;

FIG. 6 depicts a flowchart of an exemplary method for interactive account alert communications with an alert recipient with respect to an issued prepaid account to be activated using an Globally Unique IDentifier (GUID) corresponding to the alert recipient;

FIG. 7 is a screen shot illustrating an exemplary alert rendered on a display screen of a computing apparatus of an alert recipient, and pertaining to an issued prepaid account to be activated using a GUID corresponding to the alert recipient;

FIG. 8 depicts a flowchart of an exemplary method for interactive account alert communications with an alert recipient with respect to a transaction being conducted on an activated, issued prepaid account associated with a GUID corresponding to the alert recipient;

FIG. 9 is a screen shot illustrating an exemplary alert rendered on a display screen of a computing apparatus of an alert recipient, and pertaining to a deposit being made into an activated, issued prepaid account associated with a GUID corresponding to the alert recipient;

FIG. 10 is a screen shot illustrating an exemplary alert rendered on a display screen of a computing apparatus of an alert recipient, and pertaining to a transaction being conducted on an activated, issued prepaid account associated with a GUID corresponding to the alert recipient;

FIG. 11 is a screen shot rendered on a display screen of a computing apparatus by which an alert recipient interactively provides input and receives output to confirm activities relative to a prepaid account associated with a GUID corresponding to the alert recipient;

FIG. 12 depicts a block diagram illustrating an exemplary transaction processing system suitable for conducting the transactions between account holders and merchants upon accounts issued by issuers to the account holders.

### DETAILED DESCRIPTION

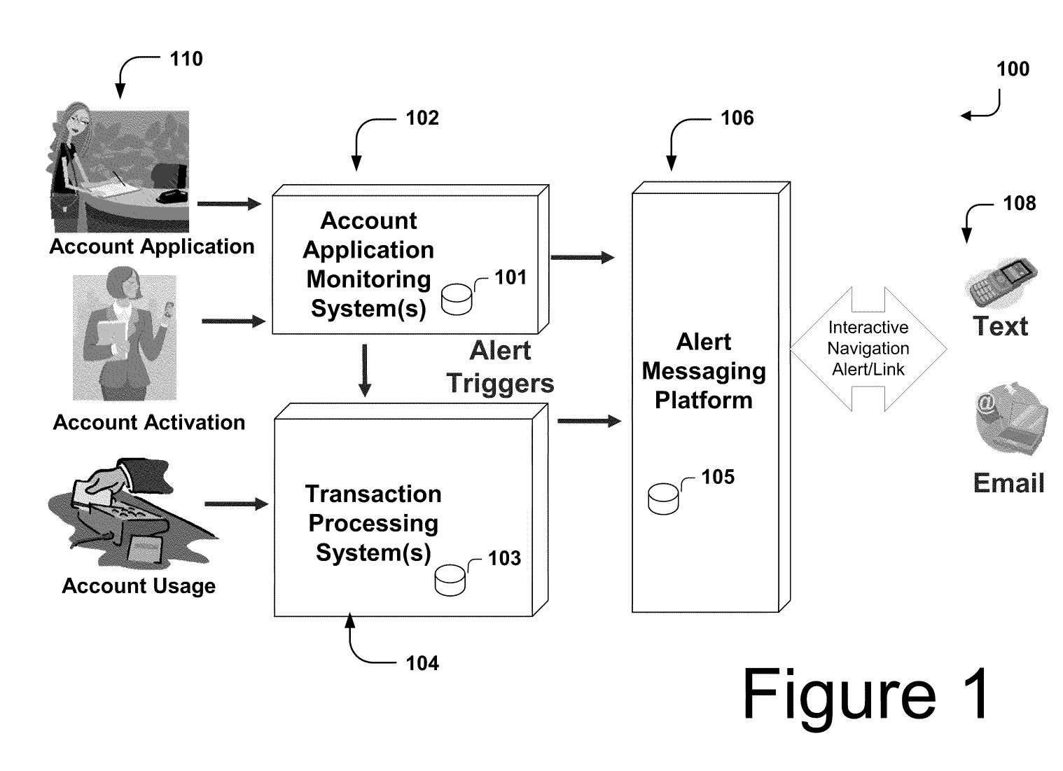

Referring to FIG. 1, a schematic illustrates an exemplary process flow for transmitting an account alert to an alert recipient within an exemplary alert system 100. The alert system 100 includes at least one alert recipient 108, such as a consumer, and at least one host, such as any of: an account application monitoring system(s) 102, transaction processing system(s) 104, and an alert messaging platform 106, or a combination of singulars or multiples of these. Although shown as separate boxes, one or more functions of the account application monitoring system(s) 102, the alert messaging platform 106, or the transaction processing system(s) 104 may be carried out by any of the application monitoring system(s) 102, the alert messaging platform 106, or the transaction processing system(s) 104.

The host may receive an account activity information 110 that includes information about activity upon an account. An account may be, for example, a checking account, a line of credit account, or a loyalty account in which points are deposited and redeemed (e.g., 50 reward points in a loyalty program can be redeemed for a $20(US) purchase). Other examples of the accounts include: debit, credit, charge, mortgage loan, stored-value, prepaid (e.g., reloadable account, Flexible Spending Account, Healthcare Savings Account), gift, commercial, corporate, government, or a combination thereof. The account activity information 110 may include data about: a request to open an account (“account application”); a request to activate an account (“account activation”); a request to deposit a currency into the account, a request for a name or address change associated with the account; an account usage such as a merchant's request to be paid for a transaction conducted by a consumer upon the account; a spend level on the account (e.g., $US50,000 spent in the month of June), or a combination of these, for example.

The host may analyze the received account activity information 110. This examination may include determining if at least one criterion of an alert rule has been satisfied, thereby triggering the sending of a corresponding account alert. Examples of criteria include: receiving an identifier in the account activity information 110 that matches a consumer indicator that uniquely identifies a particular consumer; or receiving a code indicating that the account activity information 110 includes data about at least one of an account application, an account activation, a deposit to the account, an account usage, or a combination thereof. If each of the criterion of the alert rule is satisfied, a transmission is sent that includes the account alert for delivery to the alert recipient.

The alert recipient 108 may be any entity or individual authorized to receive the account alert. For example, the alert recipient may be the consumer that has registered or enrolled to be a participant in the alert system 100, an issuer that has issued at least one account to a consumer participating in the alert system 100 (“participating consumer”), a call center that provides voice messages about the account alert to the participating consumer or the corresponding issuer, or a combination thereof.

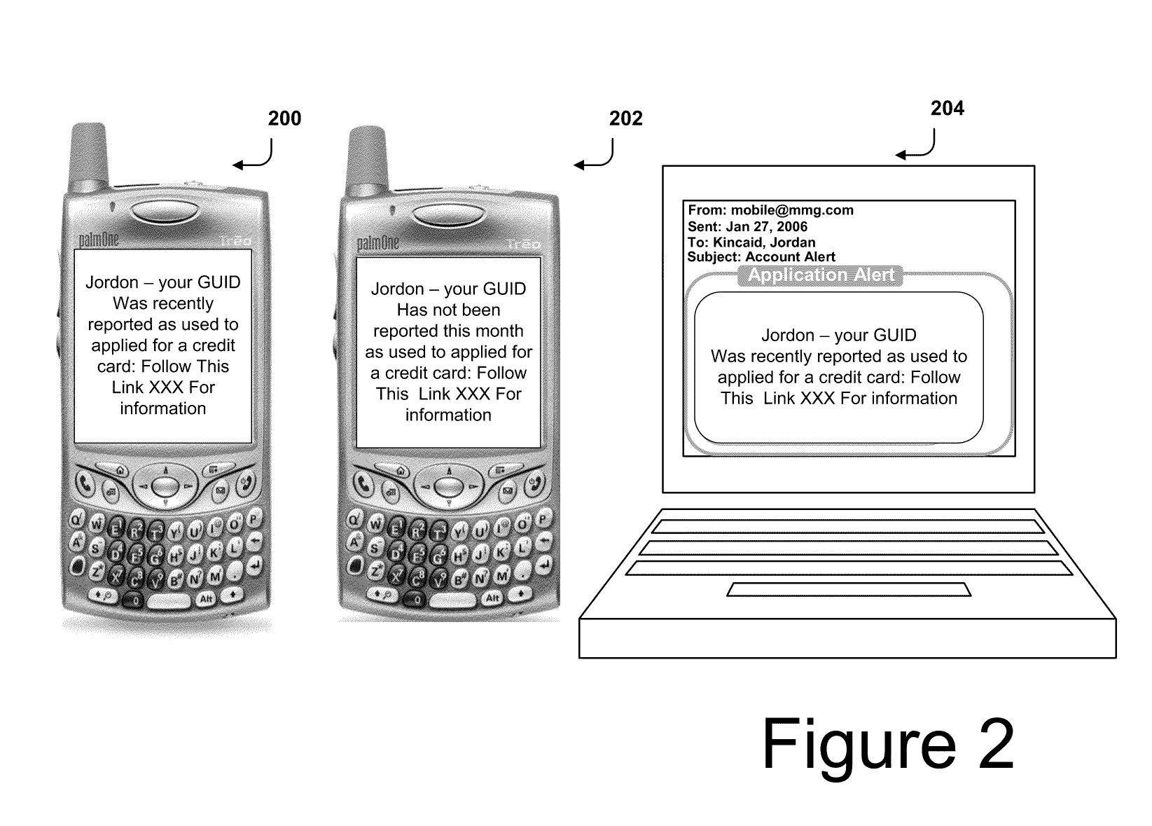

The information in the account alert may be rendered to the alert recipient in any format. Referring to FIG. 2, by way of non-limiting example, the account alert may be rendered as: an a Short Message Service (SMS) text message rendered on a display of a cellular telephone, such as a cellular telephone 200 or 202; as an e-mail displayed on a screen of a portable computing apparatus 204; or as an Internet or World Wide Web navigation hyperlink received for electronic display on a screen of a portable computing apparatus 204. Other forms of rendering of the information of the account alert are also applicable, as is know in the current art or in the future art including: an automated voice message sent to a landline telephone, an automated form letter sent to a physical address of the alert recipient, or a combination thereof.

In some implementations, the account alert may be intermittently sent to the alert recipient even if no account activity information 110 has resulted in a satisfaction of the alert rule. For example, the participating consumer may receive a monthly text message on cellular telephone 200 indicating that there has been no account alert triggering activity for that month.

Referring back to FIG. 1, the account application monitoring system(s) 102 may includes a single entity or a plurality of entities that are communicatively connected together, such as through a network. For example, the account application monitoring system(s) 102 may include at least one of: a financial institution (e.g., bank), a credit card company (e.g., American Express Travel Related Services Company, Inc.), or other entity that issues corresponding accounts to consumers. The account application monitoring system(s) 102 may also include a clearinghouse agency (e.g., Issuers' Clearinghouse Service, “ICS”) that stores and analyzes information about accounts. For example, the clearinghouse agency may store information about a bankruptcy of the consumer participating in the alert system 100, previous fraud incidences involving the consumer indicator of the consumer (e.g., a globally unique identifier for the consumer) participating in the alert system 100, or at least a portion of the account activity information 110.

The clearinghouse agency may analyze at least a portion of the account activity information 110 to determine if an account alert has been triggered by satisfaction of a corresponding alert rule. For example, the clearinghouse agency may compare an identifier in the received account activity information 110 to a consumer indicator of the consumer participating in the alert system 100.

The transaction processing system(s) 104 may include one or more of: a transaction handler, a financial institution (e.g., banks, issuers, acquirers, credit unions, savings and loan institutions, brokerages, etc.), a consumer, and a merchant. See Infra An Exemplary Transaction Processing System. The transaction processing system(s) 104 facilitates the processing of cashless transactions conducted through the use of an account. Examples of transaction processing systems include VisaNet® network, the American Express® network and the Veriphone® network.

The account application monitoring system(s) 102, the transaction processing system(s) 104, or the alert messaging platform 106 may include at least one computer to receive and transmit data, store data, or execute algorithms (e.g., software). For example, the computer within the account application monitoring system(s) 102 may execute an algorithm to determine if the criterion of the alert rule has been satisfied and to facilitate the transfer (e.g., transmission or broadcasting) of the account alert to the alert recipient, such as to the consumer.

At least one of the account application monitoring system(s) 102, the transaction processing system(s) 104, or the alert messaging platform 106 may include a database such as DB 101, DB 103, or DB 105, respectively (herein “database(s)” to indicate any one or a combination thereof). As appreciated by those skilled in the art, the DB 101, DB 103, or DB 105, or components thereof, may be any combination of databases, or the components thereof, in a single location or in multiple locations. Data stored in the database(s) may be structured by a database model, such as a relational model or a hierarchical model, where the model may govern how the data stored in the databases may be accessed. For example, query languages can be used to query the data stored in the DB 101 to locate records, or portions thereof, that are relevant to the query. The database(s) may include any of a variety of security features such as: access codes, firewalls, compression, decompression, encryption, de-encryption, or the like.

The data stored in the database(s) may include any portion of the account activity information 110, information about the alert recipient 108, formats for submission of the account alert, or other data that facilities determining: whether to send the account alert, a content of the account alert, or means for delivery of the account alert to the alert recipient. For example, the stored data may include: transaction information about transactions between at least one consumer and at least one merchant (e.g., data in the DB 103); information from corporate records; information received from the alert recipient 108, such as from an alert recipient profile created during enrollment; or information purchased from external sources who supply such information. To illustrate, the transaction information may include trends in a transaction history of an account issued to the consumer by an issuer. The corporate records may include a merchant address or a merchant's relationship with various affiliates. The alert recipient profile may include a social security number or other consumer indication associated with the consumer that uniquely identifies the consumer, account information of the consumer, or information on financial institutions that have issued accounts to the consumer. The information purchased from an external source may include a Fair Isaac Corporation (FICO) score of the consumer, for example. The consumer may be a person or a juridical entity (e.g., a business), or both.

In one implementation, the host may include both the account application monitoring system(s) 102 and the alert messaging platform 106. The account application monitoring system(s) 102 may receive the account activity information 110, compare the account activity information 110 to at least one criterion of the alert rule to find a match, and submit a transmission including information about the account alert to the messaging platform 106. The alert messaging platform 106 may, in turn, form a transmission including the account alert, where the account alert is for delivery to the alert recipient 108 in the transmission or by other means.

The information about the account alert may include: a portion of the account activity information 110, the account application monitoring system(s) 102's analysis on the account activity information 110, data about the account alert, or a combination thereof for delivery to the alert messaging platform 106.

Thereafter, the alert messaging platform 106 may transmit the account alert to the alert recipient 108. For example, the alert messaging platform 106 may retrieve a contact address (e.g., a cellular telephone number, a street address, an e-mail address) of the alert recipient 108 from the DB 105 and form a transmission for delivery to the retrieved address that includes the information about the account alert.

To illustrate, a fraudster may apply for a credit account using an identifier (e.g., a social security number or other code that uniquely identifies the consumer) of a participating consumer. A bank processing the credit account application may be part of the account application monitoring system(s) 102. The bank may forward the account activity information 110 about the account application to the ICS that is also part of the account application monitoring system(s) 102. The ICS may execute a computer algorithm to determine that the identifier in the received information is that of the consumer participating in the alert system 100 (“participating consumer”), thereby satisfying an alert rule so as to trigger formation of data for the account alert. The ICS may transmit data for the account alert to the alert messaging platform 106 that sends the account alert to the alert recipient, such as the participating consumer or an issuer of other accounts to the participating consumer, for example.

In another implementation, the host may include the account application monitoring system(s) 102, the transaction processing system(s) 104, and the alert messaging platform 106. As in the above examples, the account application monitoring system(s) 102 may receive the account activity information 110. The account application monitoring system(s) 102 may, but need not, conduct some level of analysis on the received account activity information 110 prior to sending a transmission to the transaction processing system(s) 104 including at least a portion of the received account activity information 110. The transaction processing system(s) 104 may analyze the data in the received transmission such as by comparing the account activity information 110 to at least one criterion of the alert rule to find a match. If a match is found, the transaction processing system(s) 104 may submit a transmission about the account alert to the messaging platform 106. The alert messaging platform 106 may, in turn, form a transmission including the account alert, for delivery to the alert recipient 108.

In yet another implementation, the host may include the transaction processing system(s) 104 and the alert messaging platform 106. Here, the account activity information 110 is transmitted directly to the transaction processing system(s) 104. Examples of account activity information 110 that may be directly transmitted to the transaction processing system(s) 104 include: a transaction for a resource of a merchant upon the account issued to the consumer; or an activity with the issuer that is part of the transaction processing system(s) 104. Activity with the issuer may include: activating a prepaid account using the consumer indicator of the participating consumer, depositing $US5,000 into an activated prepaid account, or using an Automated Teller Machine (ATM) to deposit or withdraw currency from an account.

As previously disclosed, the transaction processing system(s) 104 may analyze the transmitted account activity information 110, such as by executing an algorithm to compare the account activity information 110 against one or more criterion of an alert rule to determine if an account alert has been triggered. If an account alert has been triggered, information about the account alert is transmitted from the transaction processing system(s) 104 to the alert messaging platform 106 that in turn transmits the account alert to the alert recipient 108.

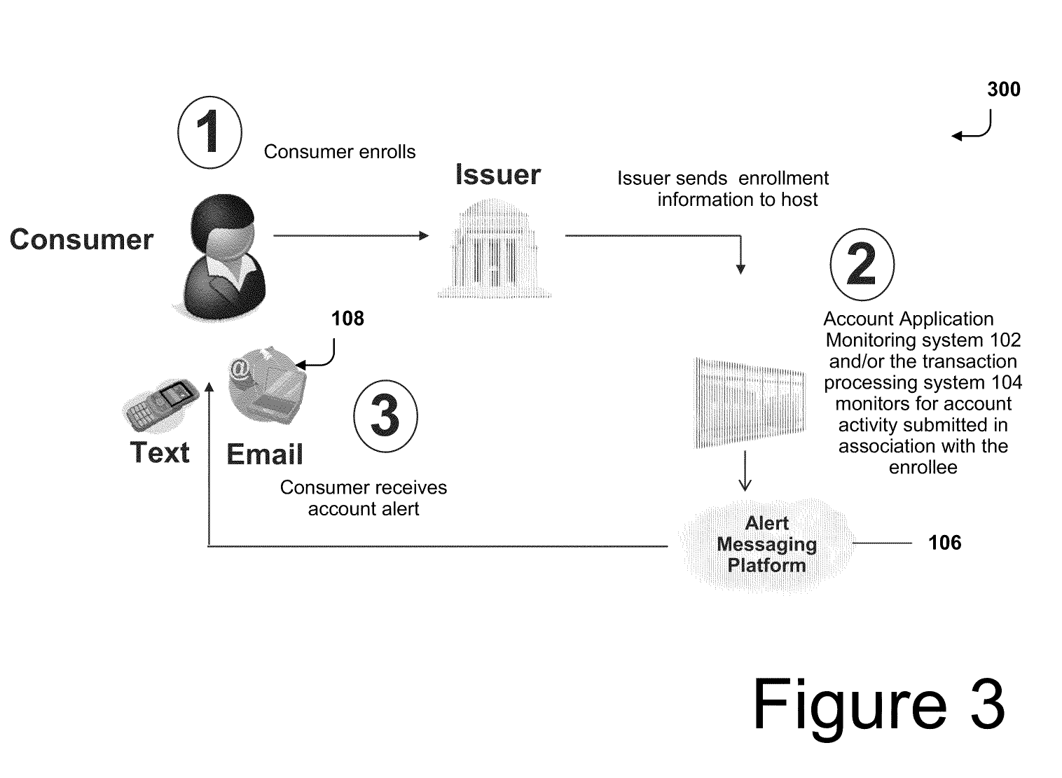

Referring to FIG. 3, a schematic illustrates an exemplary process flow 300 in which an account alert recipient receives an account alert. At process flow “1,” the consumer enrolls to become a participant in the alert system 100. For example, the consumer may access an interactive website to enroll as a participating consumer by providing information about the consumer. The information may include data such as: a name of the consumer, the consumer indicator of the consumer (e.g., social security number), data about accounts of the consumer with various corresponding issuers, demographic data about the consumer, information about preferred delivery channel (e.g., SMS or e-mail) for the account alert, or other consumer profile information. There may be a fee associated with enrolling to be a participant in the alert system 100, such as a flat fee, a monthly fee, or a per account alert fee.

The enrollment information may be submitted to an issuer. The issuer may analyze the enrollment information, such as by verifying an identity of the consumer or other verification means. The issuer may send the enrollment information to the account application monitoring system(s) 102 and/or the transaction processing system(s) 104. Alternatively, or in combination, the enrollment information may be directly submitted by the consumer to the account application monitoring system(s) 102 and/or the transaction processing system(s) 104.

At process flow “2,” the host (e.g., account application monitoring system(s) 102, the transaction processing system(s) 104, and/or the alert messaging platform 106) monitors the account activity information 110 for account activity submitted in association with the enrollee. For example, as disclosed previously, the account application monitoring system(s) 102 may receive the account activity information 110 for an account application having the consumer indicator of the participating consumer. The application monitoring system(s) 102 may determine that the account alert has been triggered and transmit the account alert to the alert messaging platform 106. The alert messaging platform 106, in turn, may transmit the account alert to the alert recipient 108, which may be the participating consumer, at process flow “3.”

The participating consumer may receive the account alert in real time (immediately), or in near real time after the time the account activity information 110 is submitted. For example, the account application monitoring system(s) 102 may receive the account activity information 110 in real-time or after a longer time from when the time the fraudster conducted the corresponding account activity. The account application monitoring system(s) 102 may then determine that the alert rule is satisfied and transmit the account alert to the alert messaging platform 106 which may be automated. The alert messaging platform 106 may then send the account alert within close temporal proximity to the receipt of the account activity information 110. Here, the time lapse between the submission of the account activity information 110 and the account alert may be anywhere from real time (i.e., immediately) to less than a week.

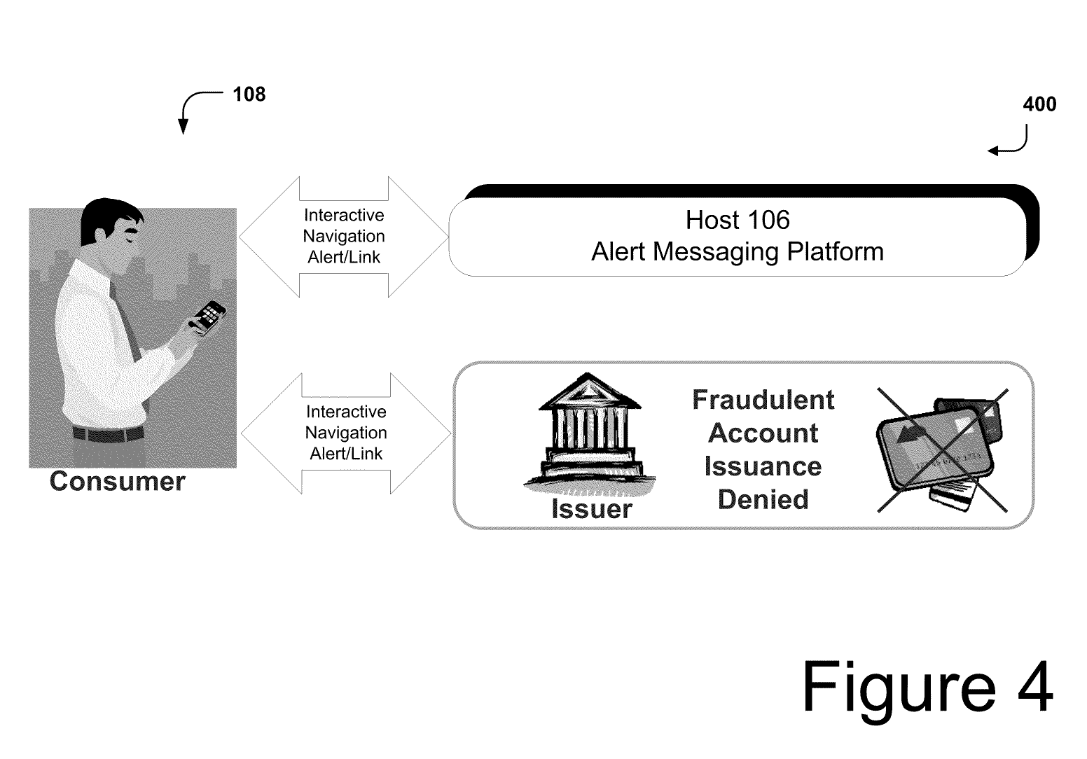

Referring to FIG. 4, the participating consumer may have several response options subsequent to receiving the account alert. For example, the participating consumer may contact the account application monitoring system(s) 102 and/or the transaction processing system(s) 104, the issuer of the account associated with the account activity information 110, or a third party in order to mitigate the affects of the suspected illicit account activity. To illustrate, the participating consumer may use a browser executing on a client operating on a mobile computing device to interactively communicate with the host in order to receive and send further information pertaining to the account alert for a new account application or activity on the account. The host may communicate to the participating consumer by sending an Internet or World Wide Web navigation hyperlink to the consumer. The participating consumer may follow the navigation link to interactively communicate with the issuer of the account associated with the account activity information 110 in order to remedy the situation, such as by supplying input indicative of the consumer's disapproval of the account application or activity on the account. The issuer may verify that the participating consumer is making a legitimate dispute by, for example, checking to see if an account alert was transmitted to the participating consumer via the alert messaging platform 106, for example. Here, if the legitimacy of the dispute is verified and the issuer agrees with the participating consumer, the new account issuance is denied and the fraudster will not be able to utilize the new account.

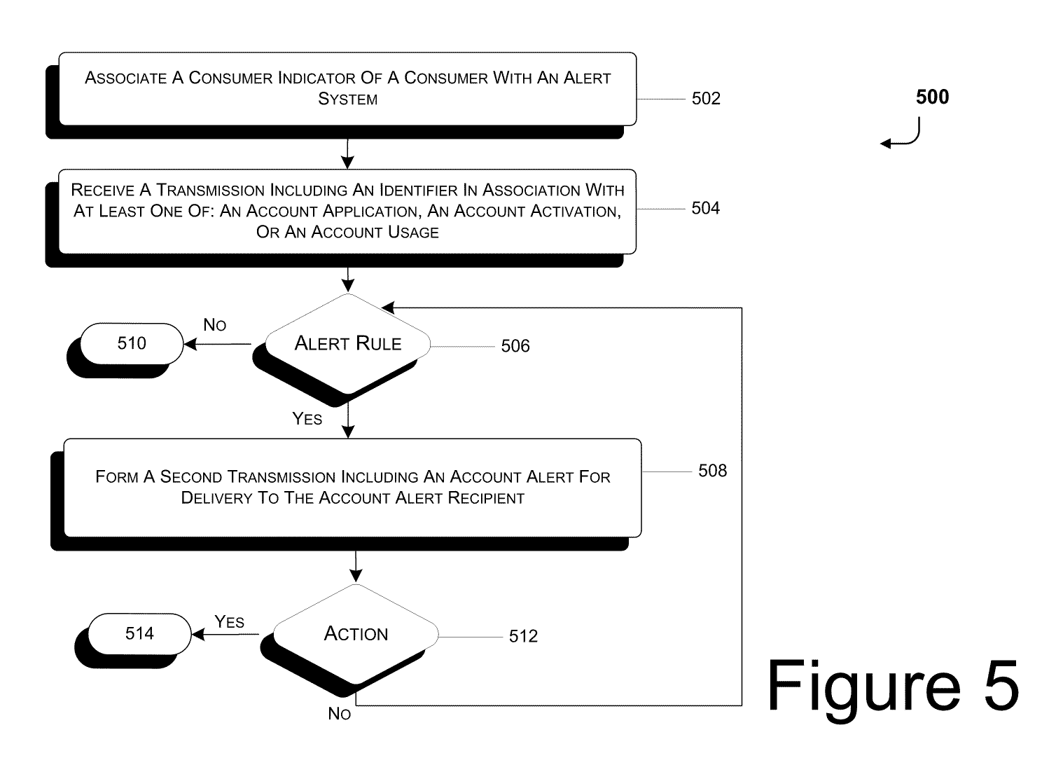

Referring to FIG. 5, a method 500 for the host to facilitate providing the account alert to the alert recipient within the environment of the FIG. 1 is depicted. At a step 502, the consumer indicator of a participating consumer is associated with the alert system 100. For example, the account application monitoring system(s) 102 and/or the transaction processing system(s) 104 or one of the issuers within the alert system 100 may provide a Globally Unique IDentifier (GUID) for the participating consumer to identify the participating consumer within the alert system 100. The GUID may be stored in the database(s) so as to be associated with the participating consumer, such as in association with the consumer profile information of the participating consumer that had been previously received during enrollment of the participating consumer in alert system 100

At a step 504, a transmission is received that includes the account activity information 110 such as an identifier that is unique to the consumer and data about at least one of: an account application, an account activation, or an account usage. For example, the host may receive the account activity information 110 from an issuer of a newly applied for credit account including the GUID of the participating consumer.

At a step 506, the account activity information 110 is analyzed in comparison to at least one criterion of the alert rule. For example, one criterion may be to receive an identifier (e.g., the GUID or a social security number) that matches at least one of the consumer indicators of the participating consumers stored in the database(s). Other criterion may include a requirement that the account activity information 110 be used for a new account application, an account activation, an account usage, or a combination of these.

If the alert rule is satisfied, such as when the received GUID matches the GUID of the participating consumer stored in the database(s), a first account alert is triggered and the method 500 moves to the step 508. Method 500 terminates at a step 510 if there is no match. At the step 508, a second transmission is formed including the first account alert for delivery to the account recipient.

At a step 512, a determination is made as to whether the account alert has resulted in the participating consumer engaging in an action to remedy the affects of account activity. For example, if the participating consumer has contacted the host or the issuer that issued the account associated with the account activity information 110, then the method 500 terminates at a step 514. Alternatively, if the participating consumer has not, within a predetermined period of time, contacted the host or the issuer that issued the account associated with the account activity information 110, the method 500 loops back from the step 512 to a repeated step 506. At the repeated step 506, another determination is made as to whether at least one criterion of the alert rule has been satisfied, such as a second criterion requiring that the participating consumer has received a previous account alert but has not yet contacted the host to try to address the information within the account alert. For example, the host may be the transaction processing system(s) 104. The issuers in the transaction processing system(s) 104 may submit data, in real-time or intermittently, to the transaction handler within the transaction processing system(s) 104. The transaction handler may store the data about the remedies in the DB 103. At the repeated step 506, the transaction handler may retrieve data about the remedies in the database(s) to determined if the participating consumer has sought one or more of the remedies in the DB 103 for the first account alert that had been previously sent to the participating consumer. If the data shows that the participating consumer has not sought a remedy, then the second criterion is satisfied and the participating consumer may receive a second account alert (e.g., the step 506 moves once again to the step 508).

In another implementation, the host receives a second account activity information 110 about an account associated with a first account alert where a second account alert is not sent. To illustrate, a participating consumer may purchase a card that corresponds to a prepaid account. Thereafter, the participating consumer may follow an Internet or World Wide Web navigation hyperlink printed on the prepaid card that corresponds to the prepaid account so as to interactively communicate regarding a request to activate the prepaid card using the social security number (or other GUID) of the participating consumer. The issuer of the account, which is a part of the account application monitoring system(s) 102, may receive the activation request. The issuer may transmit the corresponding account activity information 110 to the clearinghouse agent that is also a part of the account application monitoring system(s) 102. The clearinghouse agent compares the account activity information 110 to the alert rule to determine if an account alert has been triggered. For example, the clearinghouse agent may compare the received social security number with the social security number (or other GUID-to-GUID comparison) of corresponding participating consumers stored in the DB 101 of the clearinghouse agent. If a match is found, the first account alert is sent to the participating consumer associated with the social security number via the alert messaging platform 106. However, the participating consumer that received the first account alert may not respond to the alert because the participating consumer knows that the account activation request was legitimate. After a predetermined point of time in which the participating consumer has not responded to the first account alert, the prepaid account is activated.

The participating consumer may then use the prepaid account, such as by depositing $US5000 into the prepaid account (the steps 502 and 504). The account activity information 110 about the deposit is submitted to the transaction processing system(s) 104. At the step 506, a determination is made as to whether the criteria of the alert rule is satisfied. For example, a second criterion may be not to send a second account alert if the participating consumer has ignored a previous account alert about the same account. Here, because the participating consumer did not respond the first account alert, the step 506 would move to the step 510 and the method 500 terminates without sending the second account alert.

Various illustrations will now be made relative to alerts that are desirable for a consumer to receive as related to various implementations associated with a prepaid account. An alert to the consumer may be warranted in a circumstance in which a third party acts is not acting for the benefit of the consumer, but rather where there is the undesirable possibility that the consumer's GUID can be appropriated by the third party who is not acting in the consumer's best interest. By way of example, the third party may first appropriate the consumer's GUID in order to activate one or more prepaid accounts that have been previously issued by one or more issuers. Once activated, the prepaid account can be funded by the third party or its agent. Once funded, rather than the consumer conducting transactions on the prepaid account, without the consumer's knowledge, the third party or its agent conducts the transactions on the prepaid account with merchants for the purchase of goods and services. A potential detriment is that the funding of, and/or transactions on, a prepaid account by the third party or its agent, in effect, whether intentional or unintentional, may place the consumer in a false light.

The false light given by the funding of the prepaid accounts is that the consumer has received income that the consumer did not actually receive. The false light given by the transactions on the prepaid accounts is that the consumer has spent money that the consumer neither received nor spent. This appearance of excess income and spending may cause the consumer to come under suspicion of illegal acts. These illegal acts include hiding assets, under reporting income, money laundering, etc. The appearance given by the transactions on the prepaid accounts may place the consumer in an undesirable and false light of spending significant amounts of money for goods and services that are not representative of the consumer's personal choices or that would be viewed by others in a negative way. For instance, it may be desirable that the consumer avoid any appearance of significant spending: (i) on illegal or morally inappropriate purchases such as from a sexually oriented or gaming business; (ii) with merchants inappropriate for the consumer to conduct business, such as a competitor or a supplier of substandard goods and services; (iii) in a location where it would be inappropriate for the consumer to travel or conduct business, (iv) etc.

In an alternative of the foregoing, although a consumer may have previously activated a prepaid account, a third party may thereafter, unknown to the consumer, learn an account number for the prepaid account, and then attempt to excessively fund the prepaid account to the detriment of the consumer. In so doing, the third party may be attempting to cast a false light on the consumer as having received income that the consumer did not actually receive, such as an excessive amount of income or income that is an particular amount that draws suspicion of a related act such as a chronologically proximal theft of that particular amount. To ensure the consumer's safety, an alert service may prohibit the deposit from being made unless the consumer sends to the alert service the GUID that the consumer used to activate the issued prepaid account, which presumably will not be known to the depositor.

Implementations can be used to prohibit a third party or its agent from using a consumer's GUID to active an issued prepaid account, to fund the activated prepaid account, and/or to use the prepaid account so as to put the consumer in a false light for the purpose of harassment, public embarrassment, civil liability, and/or criminal culpability. Implementations reduce circumstances under which a third party can activate, fund, and/or transact on an issued prepaid account that is identified to a consumer.

To illustrate in reference to FIGS. 1-4, a fraudster may attempt to activate a prepaid account (e.g., activate a prepaid card associated with the prepaid account). Typically, the prepaid account is already issued but cannot be activated until it is associated with a code that uniquely identifies a specific consumer. The issuer of the prepaid account receives the account activity information 110 about the account activation. The issuer may submit the account activity information 110 to the ICS. The ICS compares the received account activity information 110 to a first criterion of the account alert to find a first match. For example, the ICS may compare an identifier in the account activity information 110 with consumer indicators of participating consumers. If a match is found, the ICS transmits a message including the at least a portion of the account activity information 110 to the transaction processing system(s) 104. The transaction processing system(s) 104 may further compare the account activity information 110 with a second criterion of the alert rule to find a second match. For example, the transaction processing system(s) 104 may compare a deposit of a currency amount into the prepaid account being activated with a threshold loading limit (i.e., the deposit exceeds a lawful threshold of $5,000 US). If the second match is also found, the account alert is triggered and the transaction processing system(s) 104 transmits data about the account alert to the alert messaging platform 106. The alert messaging platform 106, in turn, transmits the account alert to the alert recipient 108.

In another implementation, an attempt is made to activate an issued prepaid account so as to be associated with a Globally Unique IDentifier (GUID) for a consumer. The GUID is matched against an electronically stored GUID. The stored GUID has associated with it a plurality of logical addresses. The prepaid account, however, will be activated only after an electronic response is received from each logical address to which an electronic request sent. Each received electronic response will include information that corresponds to an approval of the activation of the prepaid account so as to be associated with the stored GUID. The stored GUID will be one of a plurality of other GUIDs each of which also has corresponding logical addresses. As such, prior to activating the prepaid account, an attempt will be made to match the GUID for the issued prepaid account against the stored plurality of GUIDs. Note that each logical address can be a telephone number, an electronic mail (e-mail) address, a facsimile number, a file transport protocol address, a Universal Resource Locator address (URL), a World Wide Web address, an Internet address, or combinations of these. Note also that the stored GUID can be a tax identification number for a business, a social security number, a passport identification number, a government issued identifier, a drivers license number, a biological metric identifier, or a combination of these.

In yet another implementation, a consumer can prevent an issued prepaid account from being activated so as to be associated with the consumer's Globally Unique IDentifier (GUID). Here, the consumer's GUID is received and then used to find a match in a network device. The network device stores information for a plurality of consumers. The information stored for each customer include a GUID that uniquely identifying the consumer from other consumers, and a plurality of logical addresses to which an electronic request message can be sent for delivery and from which an electronic response message can be received in response to the electronic request message. If the received GUID has a match in the GUIDs that are stored in the network device, the an electronic request message is transmitted for delivery to each of the logical addressers that correspond to the matching GUID, where the electronic request message will include a request to activate an issued and unfunded prepaid account. Upon receipt of the electronic response message from each of the logical addresses that correspond to the matching GUID, where the electronic response message includes information corresponding to an approval of the request to activate the issued and unfunded prepaid account, there will then be transmitted an approval to activate the issued and unfunded prepaid account so as to be associated with the received GUID.

In still another implementation, a consumer can prevent a deposit from being made into the consumer's activated issued prepaid account. Here, there is received identifiers for an activated prepaid account and a currency amount to be funded into the activated prepaid account. A determination is made as to whether the currency account exceeds a predetermined threshold. If so, then a network device is accessed. The network device stores for each of a plurality of consumers: (i) a Globally Unique IDentifier (GUID) uniquely identifying the consumer from other consumers; (ii) an identifier for one or more activated prepaid accounts; and (iii) a plurality of logical addresses to which an electronic request message can be sent for delivery and from which an electronic response message can be received in response to the electronic request message. If the received identifier for the activated prepaid account has a corresponding GUID stored in the network device, then the electronic request message is transmitted to each logical address corresponding to the corresponding GUID stored in the network device, where the electronic request message includes a request to fund the activated prepaid account in excess of the predetermined threshold. Upon receipt of the electronic response message from each logical address for the corresponding GUID stored in the network device, where the electronic response message includes information corresponding to an approval of the request to fund the activated prepaid account in excess of the predetermined threshold, there is transmitted an approval to fund the activated prepaid account with the currency amount.

In an alternative to the foregoing implementation, a consumer can prevent the deposit from being made into the consumer's activated issued prepaid account by failing to communicate the consumer's GUID associated with the prepaid account to the alert service. In this alternative, instead of the consumer sending an approval of the request to fund the activated issued prepaid account in excess of the predetermined threshold, the consumer can send the GUID that was used to activate the issued prepaid account. One reason for this way of approving the deposit of funds is that, while the depositor may have an account number for the activated issued prepaid account, the depositor may not have the GUID used to activate the prepaid account. As such, the consumer has the ability to prevent deposits from being made by a depositor who does not have access to the consumer's GUID, where the consumer prevents the deposit simply by not responding to one or more electronic request messages received a one or more logical addresses that are associated with the GUID stored in the network device. Also, an incorrect GUID in an electronic response message will prevent the deposit from being accepted.

In yet a still further implementation, a consumer can prevent a transaction from being conducted on the consumer's activated issued prepaid account. Here, transaction data is received that identifies an item being purchased from a merchant at a location in a transaction being conducted on an activated prepaid account. An attempt is made to match the transaction data with information stored in a network device for each of a plurality of consumers. Information for each consumer that is stored in the network device include: (i) an identifier for each of one or more activated prepaid accounts; (ii) identifiers for one or more items (e.g.; goods and/or services), identifiers for one or more merchants, and identifiers for one of more locations; (iii) a Globally Unique IDentifier (GUID) uniquely identifying the consumer from other consumers; and (iv) a logical address to which an electronic request message can be sent for delivery and from which an electronic response message can be received in response to the electronic request message. If the identifier for the activated prepaid account that is received in the transaction data has a match to one of the activated prepaid accounts that is stored in the network device, then an attempt is made to match other information in the received transaction data. If, for the matching activated prepaid account, either the item, the merchant, or the location in the received transaction data has a match in the information stored for the corresponding consumer, then an alert will be sent to the consumer.

The alert is sent to the consumer so that the consumer can prevent the transaction from being conducted. The alert will be transmitted in an electronic request message for delivery to the logical address stored for the corresponding GUID that is associated with the matching activated prepaid account. The electronic request message will include a request to approve the purchase being made in the transaction. In order for the transaction to be permitted, there must be received back, in response to each electronic request message from each logical address, an electronic response message containing the GUID corresponding to the matching activated prepaid account located in the storage of the network device. If so, then an approval of the purchase will be transmitted from an alert service or its agent to the agent bank or its agent.

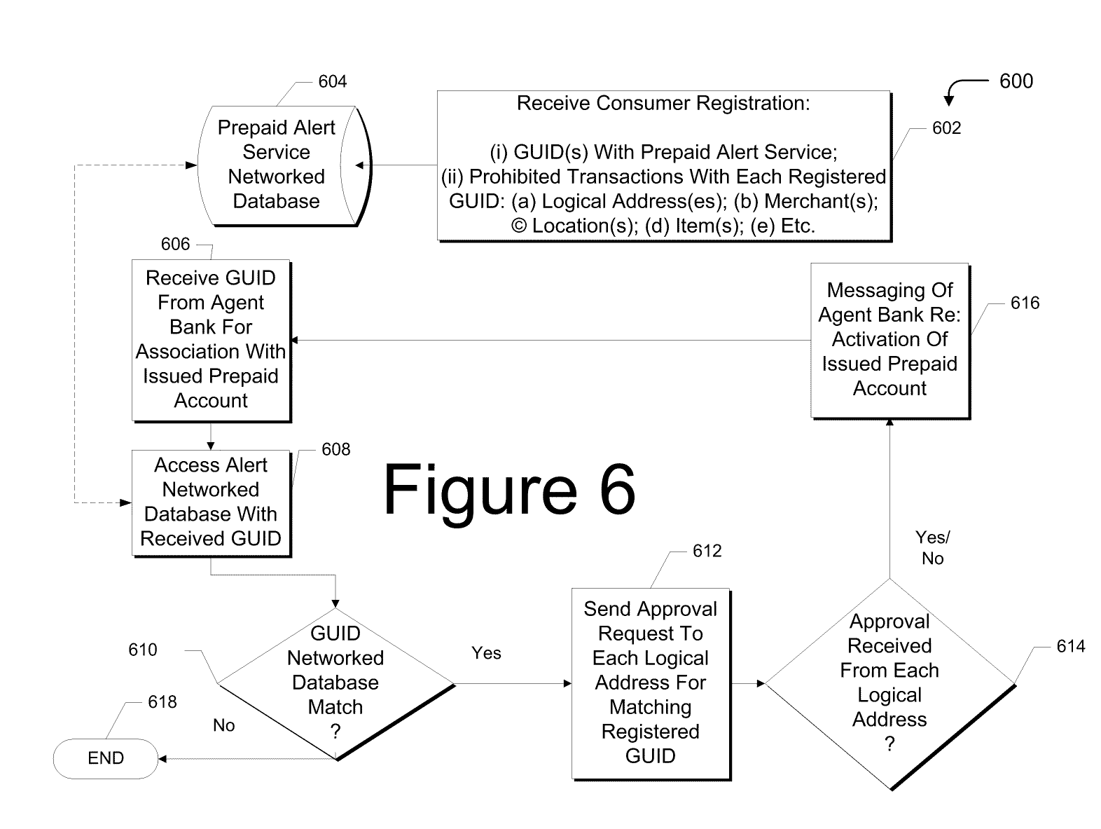

FIG. 6 depicts a flow chart of an exemplary process 600 for interactive account alert communications with an alert recipient, such as a consumer. In particular, the alert that is sent to this recipient is with respect to an issued prepaid account. The prepaid account is being attempted to be activated so as to be associated with a Globally Unique IDentifier (GUID). Process 600 begins at step 602 where a consumer registers with an alert messaging platform. The registration information that is received from the consumer will be one or more GUIDs. Each GUID is to be associated with the prepaid alert service. By way of example, the GUIDs that the consumer can send in to be registered with the alert service include a tax identification number for a business, a social security number for the consumer, a passport identification number for the consumer, a government issued drivers license number for the consumer, a biological metric identifier for the consumer such as finger print data, retinal scan data, and/or other biometrics information, which may be combined with any of the foregoing in various combinations so as to uniquely identify the particular consumer from other consumers. Additionally, with each GUID, the consumer may register particular aspects of transactions that the consumer wishes to prohibit from being conducted with any prepaid account that is associated with the consumer's registered GUID. Such transactions that are prohibited include certain merchants with whom the consumer will not do business, certain locations at which the consumer will not conduct business, and certain items which the consumer will not purchase or does not want to be known to have purchased. Additionally, each registered GUID for the consumer will be associated with one or more logical addresses. These logical addresses include email addresses, cellular telephone addresses, URLs, internet addresses, World Wide Web addresses, facsimile addresses, landline telephone addresses, and any other logical address to which an electronic communication could be directed and from an electronic response message could be received.

Information submitted by the consumer at step 600 is stored in a network device, which could be a plurality of apparatus in communication with the alert service. By way of example, see reference numeral 604 in FIG. 6 titled prepaid alert service network database. After the consumer registers information with the alert service, process 600 moves to step 606. With each GUID registered by the consumer with the alert service, the consumer can also register: (i) one or more identifiers for respective prepaid accounts; (ii) one or more logical addresses; (iii) one or more identifiers for respective merchant(s); (iv) one or more identifiers for respective location(s); and (v) one or more identifiers for respective Item(s).

Steps 606 through 616 of process 600 illustrate methodology by which a consumer can prevent or allow an issued prepaid account from being activated so as to be associated with a GUID that the consumer registered for storage in prepaid service network database 604. At step 606, the alert service receives from an agent bank a GUID that an applicant seeks to have associated with an issued prepaid account. At step 608, access is made to the prepaid service network database 604 in order to determine whether or not a matching GUID can be found with the GUID that was received from the agent bank. At step 610, if the match isn't found between the received GUID and any of the GUIDs that have been stored in database 606, then process 600 terminates at step 618, although a corresponding diagnostic may be sent from the alert service to the agent bank. If a match is found between the received GUID and the stored GUIDs in the network database 604, then process 600 moves to 612.

At step 612 of process 600, a request for approval is sent to each logical address that is found in the network database 604 that is associated with the stored, matching GUID. If a match is found between a registered GUID stored network devices database 604 and the GUID received from the agent bank, each logical address will receive an electronic request for approval. At step 614, a query is made as to whether or not an approval response has been received by the alert service or its agent in response to each approval request sent to each logical address that is associated with the matching stored GUID. If any one logical address does not return an electronic response to the electronic request, then the approval to activate an issued prepaid account is terminated in a decline. If, however, the query at step 614 results in an acknowledgement response being received in response to each of the electronic requests from each of the logical address, then process 600 moves step 616.

According to the result of the query at step 614, a message is formatted and sent by the alert service to the agent bank at step 616 of process 600. The message may be a decline of the activation of the issued prepaid account, or it may be an approval of the activation of the issued prepaid account. As such, the agent bank receives the message at step 616 of process 600. The flow chart seen for process 600 repeats steps 606 through 616 for each attempt to activate an issued prepaid account by use of a GUID.

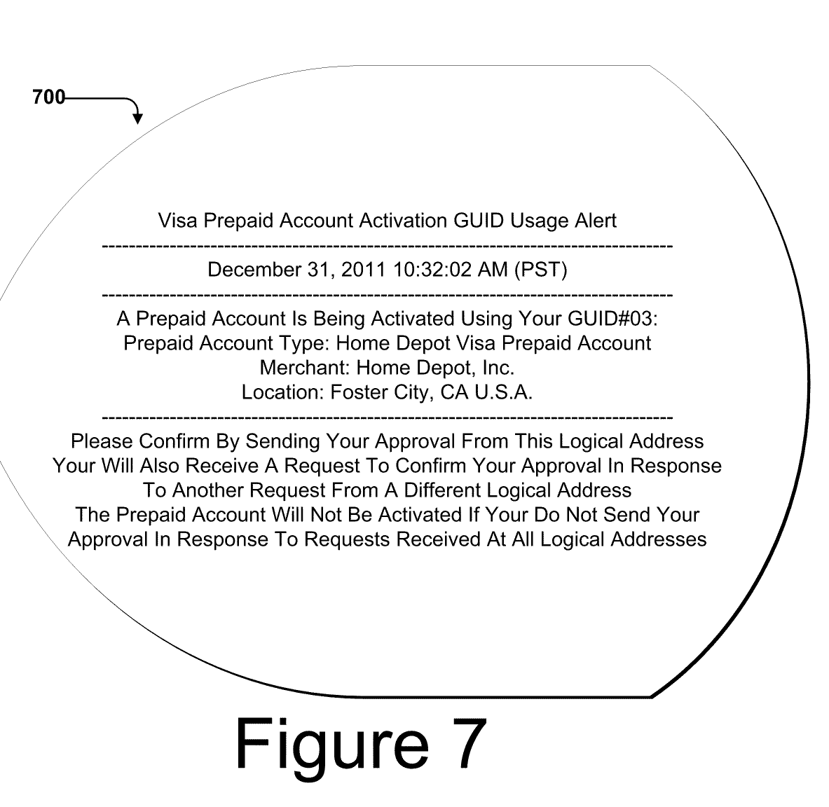

FIG. 7 shows a screen shot 700 illustrating an exemplary alert rendered on a display screen of a computing apparatus of an alert recipient. Screen shot 700 represents an exemplary message received by a consumer at a logical address corresponding to a Globally Unique IDentifier (GUID) that the consumer registered with the alert service. In the case of screen shot 700, the consumer has registered to receive notices whenever the particular ‘GUID No. 03’ is being offered incident to activating to an issued prepaid account. In this case, the alert for activating such an issued prepaid account was received on Dec. 31, 2011 at 10:32 and 2 seconds a.m., Pacific Standard Time. The diagnostic received by the consumer containing information acknowledging that the ‘GUID No. 03’ is being offered to open a prepaid account with the merchant ‘Home Depot’ in a location known as Foster City, Calif. USA. In order for the consumer to respond to this diagnostic so as to permit the prepaid account to be activated, the consumer must respond by sending an approval from the logical address associated with the portable consumer device that displayed screen shot 700. If any one such diagnostic sent to any one logical address is not affirmatively responded to by the consumer, then the prepaid account will not be activated. Accordingly, each logical address to which an electronic request is sent must send an electronic response to the alert service in order to activate the issued prepaid account.

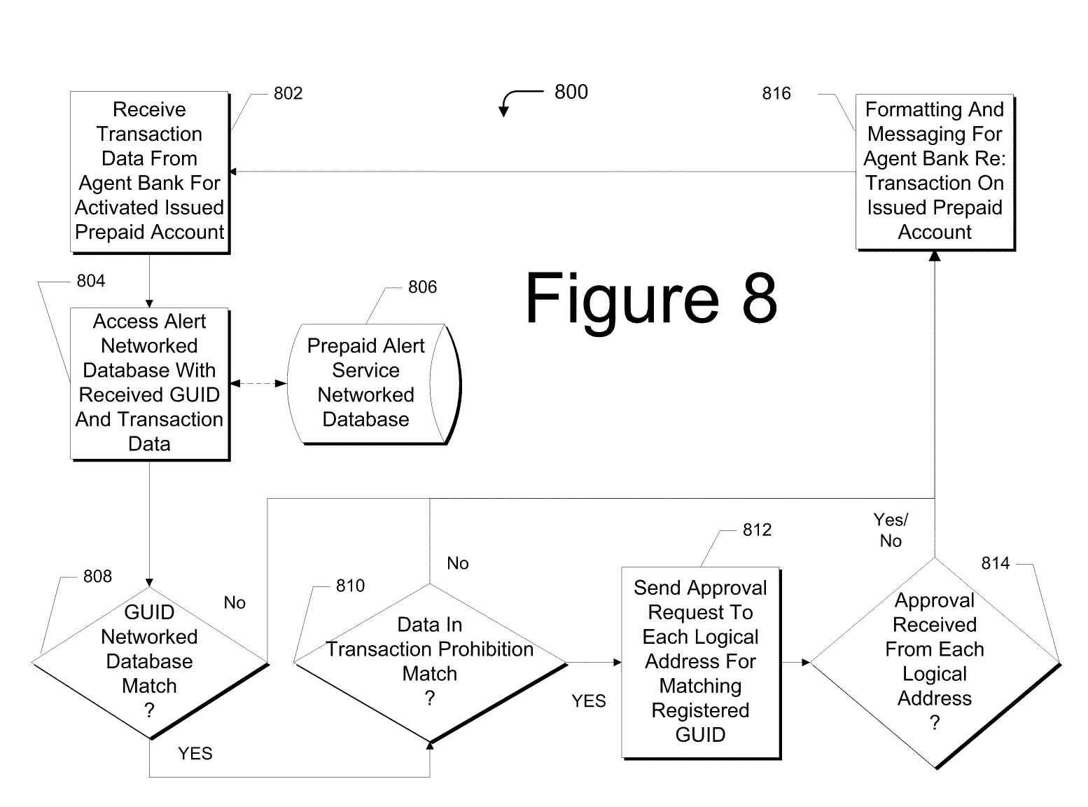

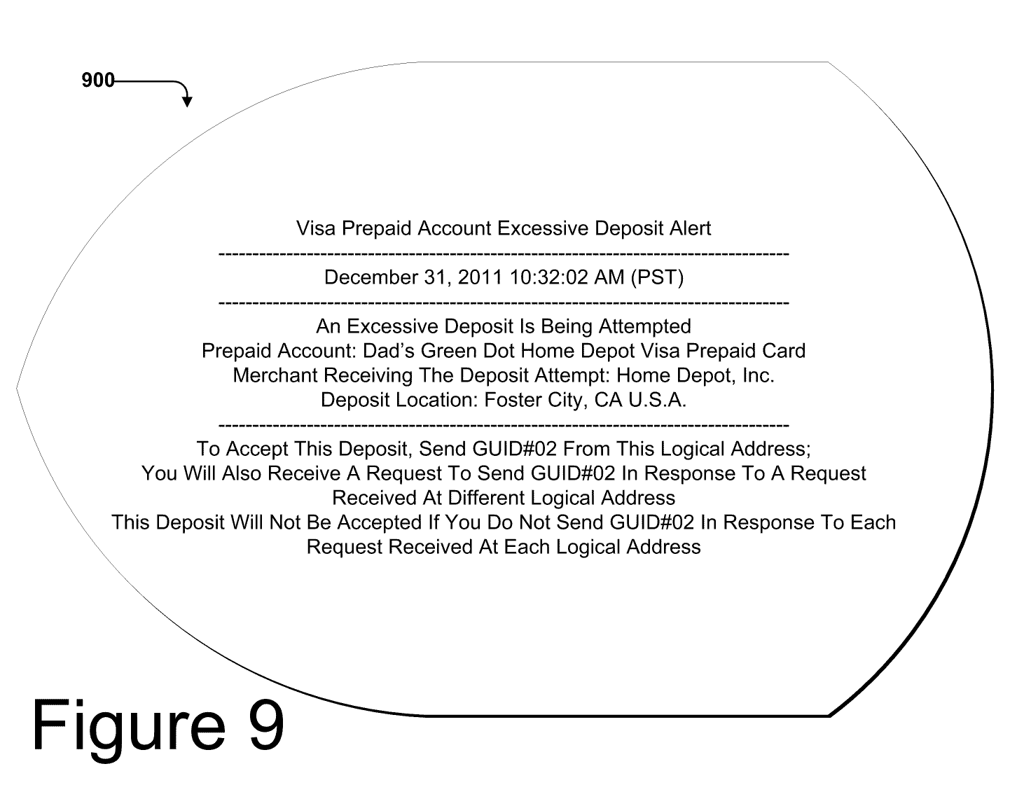

FIG. 8 illustrates exemplary methodology by which a consumer can prevent or allow a transaction from being conducted on an activated issued prepaid account that is associated with a GUID that the consumer registered for storage with an alert service. A flow chart seen in FIG. 8 depicts a process 800 that begins at step 802. At step 802, transaction data is received by an alert service from an agent bank with respect to an activated issued prepaid account that is identified in the transaction data. The issued prepaid account has a GUID associated with it at the time the issued prepaid account was activated. Process 800 moves to step 804 where access is gained to an alert network database. By using the identifier for the activated issued prepaid account, a GUID can be determined to exist or not exist within prepaid alert service network database 806. This determination is made at the query at step 808.

By way of example, and not by way of limitation, network database 806 can have stored, for each GUID corresponding to a consumer: (i) one or more identifiers for respective prepaid accounts; (ii) one or more logical addresses; (iii) one or more identifiers for respective merchant(s); (iv) one or more identifiers for respective location(s); and (v) one or more identifiers for respective item(s). If a matching GUID is found in the network database 806, then process 800 moves to step 810. If, however, no matching GUID is found in database 806 for the activated issued prepaid account and the transaction data, then process 800 moves to step 816 where the agent bank is sent a formatted message accordingly.

If the query at step 808 is in the affirmative that a match has been found, then the query at step 810 determines whether any information in the transaction data can be matched to prohibited data that is stored for the GUID associated with the matching activated issued prepaid account in the network database 806. If no transaction data of a prohibitive nature is found to be associated with the GUID in the network database 806, then the agent bank is messaged accordingly at step 816 of process 800. If, however, the transaction data is found to include prohibitive data, then a corresponding electronic request message is sent out at step 812 to each logical address given by the consumer registering the GUID with which the issued prepaid account was activated. In order for the consumer to prevent the transaction from being conducted, the consumer simply needs to not respond to any one of the electronic request messages received at one or more logical addresses associated with the consumer's registered GUID. Alternatively, in order for the consumer to allow the transaction to be being conducted, despite the presence of proscribed information in the transaction data, the consumer must send an electronic response message to each of the electronic request messages received at each of the one or more logical addresses associated with the consumer's registered GUID.

By way of example, the transaction data received by the alert service from an agent bank may be found to include proscribed information that is associated with the consumer's registered GUID via a corresponding activated issued prepaid account in network database 806. The consumer may have registered a prohibitive location where the consumer does not wish that transactions be permitted to be conducted. Alternatively, a merchant with whom the consumer has requested not to do business could be found in network database 806 to be associated with the GUID. Again, other prohibitive data may be an item that the consumer had requested not to be purchased on an activated issued prepaid account that is associated with the consumer's registered GUID. As such, each location, each merchant and each purchased item can be proscribed by the consumer's use of the alert service. The determination of whether or not prohibitive data is found in the transaction data is made in the query at step 810. Whether the transaction is to be permitted because no matching transaction data was found in network database 806, or whether no match was found for the GUID associated with the issued prepaid account in network database 806, in either case, the agent bank is sent a formatted message by the alert service accordingly in step 816 of process 800.

FIG. 900 shows an exemplary display screen shot 900 which is sent via an electronic request message to a consumer registered GUID with the alert service. In the case of screen shot 900, an excessive deposit is being attempted to be made into an activated issued prepaid account associated with the consumer's registered GUID. As shown in screen shot 900, the deposit is being attempted on Dec. 31, 2011 at 10:32 and 2 seconds a.m., Pacific Standard Time. The prepaid account associated with the consumer's registered GUID is ‘Dad's Green Dot Home Depot Visa Prepaid Card’. In this case, the merchant receiving the deposit attempt is Home Depot Incorporated located in Foster City, Calif. USA. The alert informs the consumer on screen shot 900 that, and in order to accept the excessive deposit, which in this case is associated with a Visa prepaid card corresponding to ‘GUID No, 02’, then the consumer must send an electronic response to the electronic request rendered on screen shot 900 from each of the one or more logical addresses that had been previously registered by the consumer so as to be associated with the ‘GUID No, 02’. If any one electronic response is not sent from the logical address at which the electronic request was received, then the deposit will be refused by agent bank who will be sent a correspondingly effective message. Accordingly, for a consumer to prohibit the deposit, the consumer simply need not respond to even one of the electronic requests that the consumer received.

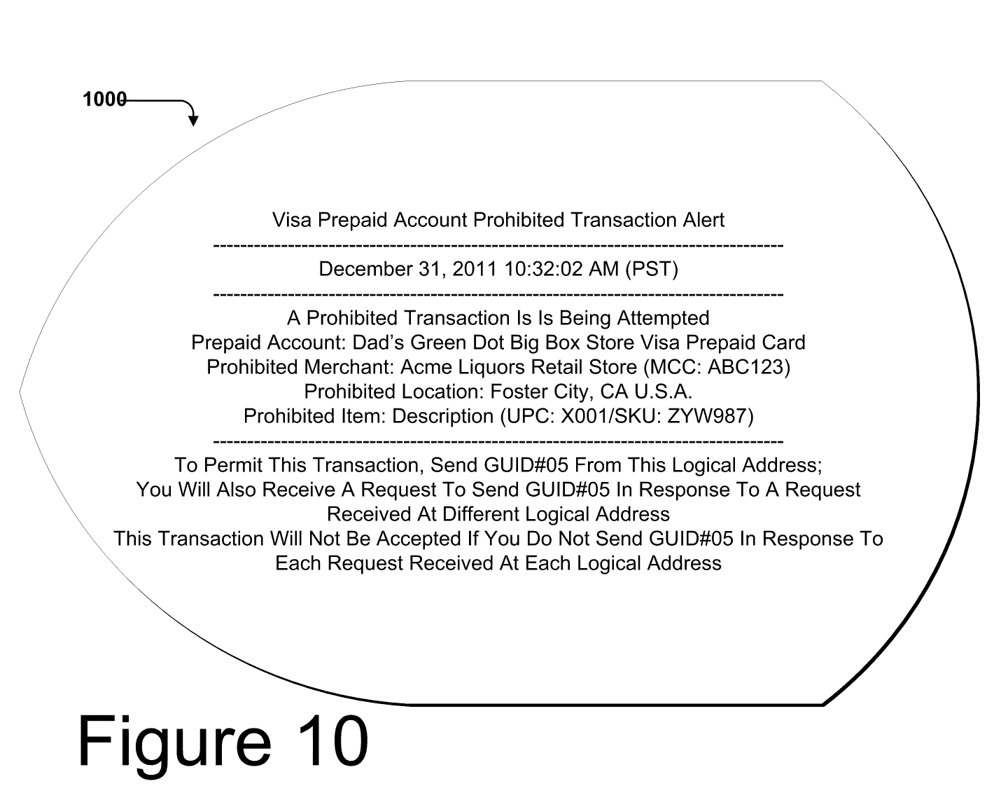

FIG. 10 is a screen shot 1000 having rendered thereon an electronic request on a display screen of a computing apparatus of a consumer. The rendered alert pertains to a transaction being conducted on an activated, issued prepaid account associated with a GUID previously registered by the consumer with an alert service. Preceding the consumer's receipt of the alert, transaction data is sent from an agent bank to an alert service, and the alert service then sends the alert to the consumer as an electronic request to permit a corresponding transaction. In this case, the transaction has been determined to include prohibitive data that was previously associated with a consumer's registered ‘GUID No. 5’ and a particular Visa prepaid card. In this case, the prohibitive data was determined to exist on Dec. 31, 2010 at 10:32 and 2 seconds a.m. Pacific Standard Time. The prepaid account upon which the transaction is being conducted is ‘Dad's Green Dot Big Box Store Visa prepaid card’, where a prohibitive merchant was determined to be ‘ACME Liquors Retail Store’ having a merchant commodity code (MCC) of ‘ABC123’, where the prohibitive transaction is taking place in Foster City, Calif. USA, and the prohibited item being purchased was described via Universal Product Code (UPC) X001 and Stock Keeping Unit (SKU) ZYW987. In order for the consumer to override the prohibitive data and thereby permit the transaction to be conducted, the consumer must respond with an electronic response to each electronic request received at each logical address registered by the consumer so as to be associated with the consumer's ‘GUID No. 5’. Accordingly, in order to prohibit the transaction from being conducted, the consumer simply need not respond to one or more different electronic requests as received at each logical address.

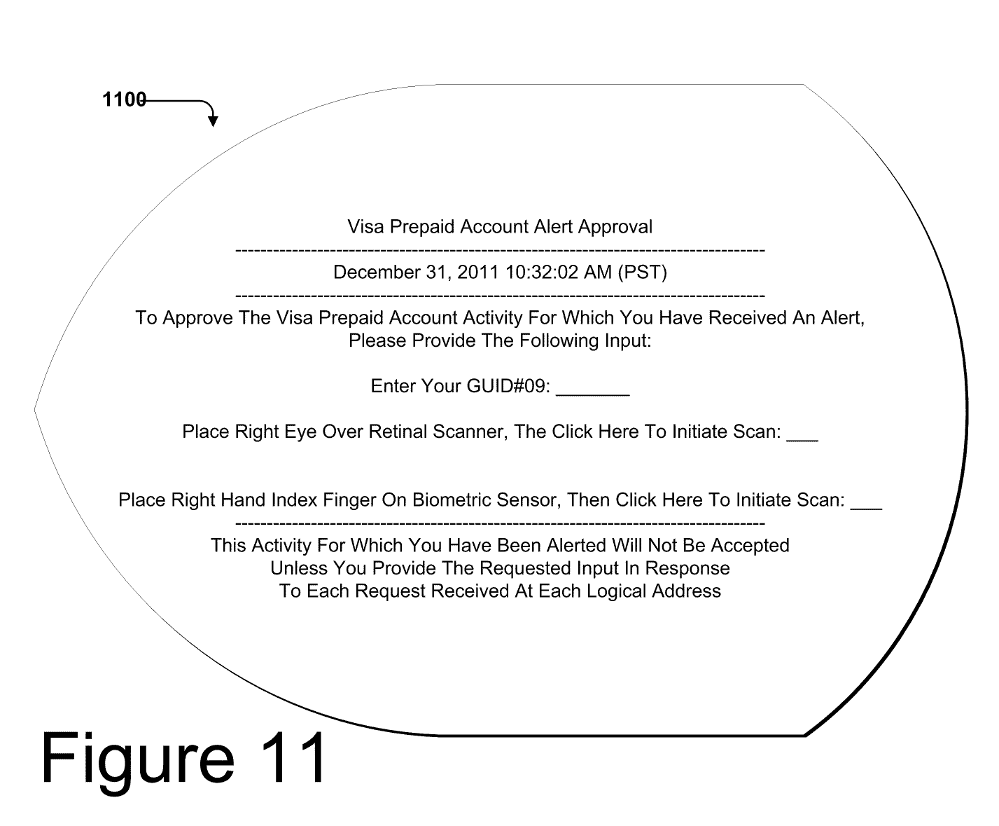

FIG. 11 is a screen shot 1100 having rendered thereon an electronic request on a display screen of a computing apparatus of a consumer. The rendered alert pertains to a diagnostic asking for input from the consumer to be provided to an alert system. In this case, the alert has asked for input on Dec. 31, 2011 at 10:32 and 2 seconds a.m. Pacific Standard Time. In particular, the consumer is being asked to approve activity on a Visa prepaid account. The input that is being requested is as follows: (i) an identifier for ‘GUID No. 09’; (ii) a retinal scan of the consumer's right eye; and (iii) biometric data retrieved from the consumer's right index finger. In this interactive screen shot 1100, once the input is ready to be received, the user clicks on the indicted respective navigational icons, as is typical of interactive screen displays rendered by clients executing on computing apparatus. Each such ‘click’ initiates the transmission of the requested input to the alert service. In the event, however, that the consumer does not provide the requested input, then an approval will not be deemed to be received from the consumer, where each approval and input must be received from each logical address to which an electronic request has been sent. If any one electronic response has not been sent as a reply to each electronic request, then the consumer's approval will be deemed to have not been obtained and the alert service will not permit an activity relative to a prepaid account for which the alert service has sent the electronic request to the consumer.

### An Exemplary Transaction Processing System

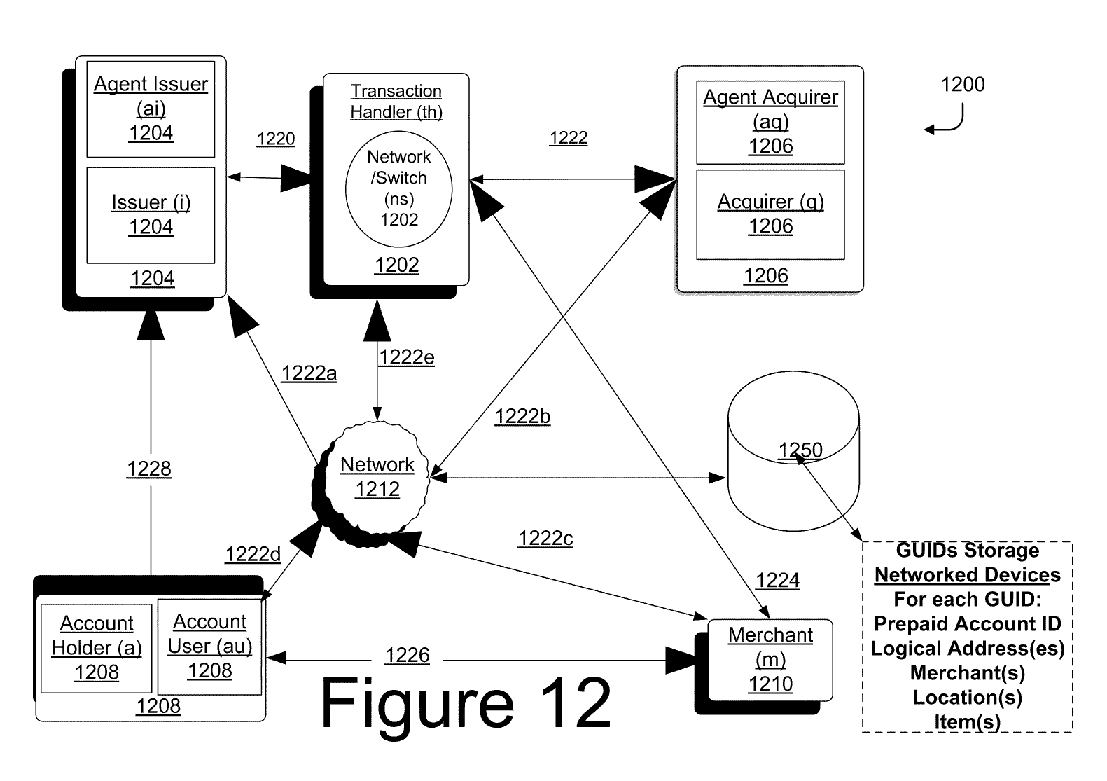

Referring to FIG. 12, the transaction processing system 1200 can be operated in the environment of FIG. 1 in which an alert recipient of the implementations disclosed herein can receive the account alert. The general environment of FIG. 12 includes that of a merchant (m) 1210, such as the merchant, who can conduct a transaction for goods and/or services with an account user (au) (e.g., consumer) on an account issued to an account holder (a) 1208 by an issuer (i) 1204, where the processes of paying and being paid for the transaction are coordinated by at least one transaction handler (th) 1202 (e.g., the transaction handler) (collectively “users”). The transaction includes participation from different entities that are each a component of the transaction processing system 1200.

The transaction processing system 1200 may have at least one of a plurality of transaction handlers (th) 1202 that includes transaction handler (1) 1202 through transaction handler (TH) 12020, where TH can be up to and greater than an eight digit integer.

The transaction processing system 1200 has a plurality of merchants (m) 1210 that includes merchant (1) 1210 through merchant (M) 1210, where M can be up to and greater than an eight digit integer. Merchant (m) 1210 may be a person or entity that sells goods and/or services. Merchant (m) 1210 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 1208 may be a second merchant (m) 1210 making a purchase from another merchant (m) 1210.

Transaction processing system 1200 includes account user (1) 1208 through account user (AU) 1208, where AU can be as large as a ten digit integer or larger. Each account user (au) conducts a transaction with merchant (m) 1210 for goods and/or services using the account that has been issued by an issuer (i) 1204 to a corresponding account holder (a) 1208. Data from the transaction on the account is collected by the merchant (m) 1210 and forwarded to a corresponding acquirer (a) 1206. Acquirer (a) 1206 forwards the data to transaction handler (th) 1202 who facilitates payment for the transaction from the account issued by the issuer (i) 1204 to account holder (a) 1208.

Transaction processing system 1200 has a plurality of acquirers (q) 1206. Each acquirer (q) 1206 may be assisted in processing one or more transactions by a corresponding agent acquirer (aq) 1206, where ‘q’ can be an integer from 1 to Q, where aq can be an integer from 1 to AQ, and where Q and AQ can be as large as a eight digit integer or larger. Each acquirer (q) 1206 may be assisted in processing one or more transactions by a corresponding agent acquirer (aq) 1206, where ‘q’ can be an integer from 1 to Q, where aq can be an integer from 1 to AQ, and where Q and AQ can be as large as a eight digit integer or larger.

The transaction handler (th) 1202 may process a plurality of transactions within the transaction processing system 1200. The transaction handler (th) 1202 can include one or a plurality or networks and switches (ns) 1202. Each network/switch (ns) 1202 can be a mainframe computer in a geographic location different than each other network/switch (ns) 1202, where ‘ns’ is an integer from one to NS, and where NS can be as large as a four digit integer or larger.

Dedicated communication systems 1220, 1222 (e.g., private communication network(s)) facilitate communication between the transaction handler (th) 1202 and each issuer (i) 1204 and each acquirer (a) 1206. A Network 1212, via e-mail, the World Wide Web, cellular telephony, and/or other optionally public and private communications systems, can facilitate communications 1222a-1222e among and between each issuer (i) 1204, each acquirer (a) 1206, each merchant (m) 1210, each account holder (a) 1208, and the transaction handler (th) 1202. Alternatively and optionally, one or more dedicated communication systems 1224, 1226, and 1228 can facilitate respective communications between each acquirer (a) 1206 and each merchant (m) 1210, each merchant (m) and each account holder (a) 1208, and each account holder (a) 1208 and each issuer (i) 1204, respectively.

The Network 1212 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 1212 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 1212 may utilize any of a variety of communication protocols, such as Transmission Control Protocol/Internet Protocol (TCP/IP), for example. There may be multiple nodes within the network 1212, each of which may conduct some level of processing on the data transmitted within the transaction processing system 1200.

Users of the transaction processing system 1200 may interact with one another or receive data about one another within the transaction processing system 1200 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 1200 by the account holder (a) 1208 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 1208's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 1210 may utilize at least one POI terminal (e.g., Point of Service or browser enabled consumer cellular telephone); that can communicate with the account user (au) 1208, the acquirer (a) 1206, the transaction handler (th) 1202, or the issuer (i) 1204. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 1210 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 1200.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 1210. These data can include an account identifier of a healthcare account. In another example, the POI may be the PCD of the consumer, such as the cellular telephone of the consumer, where the merchant (m) 1210, or an agent thereof, receives the account identifier of the consumer via a webpage of an interactive website rendered by a browser executing on a World Wide Web (Web) enabled PCD.

Typically, a transaction begins with account user (au) 1208 presenting the portable consumer device to the merchant (m) 1210 to initiate an exchange for resources (e.g., a good or service). The portable consumer device may be associated with an account (e.g., a credit account) of account holder (a) 1208 that was issued to the account holder (a) 1208 by issuer (i) 1204.

Merchant (m) 1210 may use the POI terminal to obtain account information, such as a number of the account of the account holder (a) 1208, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 1204 of the account associated with the PCD. Alternatively, or in combination, the PCD may communicate with issuer (i) 1204, transaction handler (th) 1202, or acquirer (a) 1206.

Issuer (i) 1204 may authorize the transaction and forward same to the transaction handler (th) 1202. Transaction handler (th) 1202 may also clear the transaction. Authorization includes issuer (i) 1204, or transaction handler (th) 1202 on behalf of issuer (i) 1204, authorizing the transaction in connection with issuer (i) 1204's instructions such as through the use of business rules. The business rules could include instructions or guidelines from the transaction handler (th) 1202, the account holder (a) 1208, the merchant (m) 1210, the acquirer (a) 1206, the issuer (i) 1204, a related financial institution, or combinations thereof. The transaction handler (th) 1202 may, but need not, maintain a log or history of authorized transactions. Once approved, the merchant (m) 1210 may record the authorization, allowing the account user (au) 1208 to receive the good or service from merchant (m) or an agent thereof.

The merchant (m) 1210 may, at discrete periods, such as the end of the day, submit a list of authorized transactions to the acquirer (a) 1206 or other transaction related data for processing through the transaction processing system 1200. The transaction handler (th) 1202 may optionally compare the submitted authorized transaction list with its own log of authorized transactions. The transaction handler (th) 1202 may route authorization transaction amount requests from the corresponding the acquirer (a) 1206 to the corresponding issuer (i) 1204 involved in each transaction. Once the acquirer (a) 1206 receives the payment of the authorized transaction from the issuer (i) 1204, the acquirer (a) 1206 can forward the payment to the merchant (m) 1210 less any transaction costs, such as fees for the processing of the transaction. If the transaction involves a debit or pre-paid card, the acquirer (a) 1206 may choose not to wait for the issuer (i) 1204 to forward the payment prior to paying merchant (m) 1210.

There may be intermittent steps in the foregoing process, some of which may occur simultaneously. For example, the acquirer (a) 1206 can initiate the clearing and settling process, which can result in payment to the acquirer (a) 1206 for the amount of the transaction. The acquirer (a) 1206 may request from the transaction handler (th) 1202 that the transaction be cleared and settled. Clearing includes the exchange of financial information between the issuer (i) 1204 and the acquirer (a) 1206 and settlement includes the exchange of funds. The transaction handler (th) 1202 can provide services in connection with settlement of the transaction. The settlement of a transaction includes depositing an amount of the transaction settlement from a settlement house, such as a settlement bank, which transaction handler (th) 1202 typically chooses, into a clearinghouse bank, such as a clearing bank, that acquirer (a) 1206 typically chooses. The issuer (i) 1204 deposits the same from a clearinghouse bank, such as a clearing bank, which the issuer (i) 1204 typically chooses, into the settlement house. Thus, a typical transaction involves various entities to request, authorize, and fulfill processing the transaction.

The transaction processing system 1200 will preferably have network components suitable for scaling the number and data payload size of transactions that can be authorized, cleared and settled in both real time and batch processing. These include hardware, software, data elements, and storage network devices for the same. Examples of transaction processing system 1200 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 1202 can include one or more data centers for processing transactions, where each transaction can include up to 100 kilobytes of data or more. The data corresponding to the transaction can include information about the types and quantities of goods and services in the transaction, information about the account holder (a) 1208, the account user (au) 1208, the merchant (m) 1210, tax and incentive treatment(s) of the goods and services, coupons, rebates, rewards, loyalty, discounts, returns, exchanges, cash-back transactions, etc.

By way of example, network/switch (ns) 1202 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 1204 (or agent issuer (ai) 1204 thereof) and each acquirer (a) 1206 (or agent acquirer (aq) 1206 thereof) can use or more router/switch (e.g., Cisco™ routers/switches) to communicate with each network/switch (ns) 1202 via dedicated communication systems.

Transaction handler (th) 1202 can store information about transactions processed through transaction processing system 1200 in data warehouses such as may be incorporated as part of the plurality of networks/switches 1202. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 1200 over paying and being paid by cash, or other traditional payment mechanisms.

The VisaNet® system is an example component of the transaction handler (th) 1202 in the transaction processing system 1200. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 1210. In 2007, around 71 billion transactions for about 4 trillion U.S. dollars were cleared and settled through the VisaNet® system, some of which involved a communication length of around 24,000 miles in around two (2) seconds.

As previously disclosed, an example for one or more of the transaction processing system(s) 104 in FIG. 1 is seen by the transaction processing system 1200 of FIG. 12. As such, transaction processing system 1200 can be used in an alert system for which an alert recipient of the implementations disclosed herein can receive an account alert. For example, the transaction handler (th) 1202 may store the account activity information 110 that is received from the issuer (i) 1204 of the corresponding account; determine if the account alert has been triggered; transmit the information about the account alert to the alert messaging platform 106; or any combination thereof. Moreover, the account activity information 110 may be, for example, a transaction upon the account for the resources of the merchant (m) 1210. Alternatively, the account activity information 110 may be an activity of the consumer, shown as an account holder (a) 1208 or the account user (au) 1208, upon the account such as when the account holder (a) 1208 or account user (au) 1208 deposits and/or redeems currency or points into/from an account managed by the issuer (i) 1204 that forwards data about the deposit/redemption to the transaction handler (th) 1202.

In other implementations, an alert system provides an incentive to a consumer when a corresponding alert recipient responds to an account alert. In variations of such implementations, the alert system provides an incentive to the consumer when the corresponding alert recipient responds to the account alert within a predetermined period of time after receipt of the account alert. In still further variations of such implementations, incentives provided to the consumer vary depending upon the type of the account alert, the nature, quality and degree of the response by the alert recipient, and/or the time between the delivery of the account alert and the response(s) by the alert recipient. Incentives provided in such implementations include an amount and type of currency deposited to a legitimate account issued to the consumer (i.e., US dollars, loyalty points redeemable for goods and/or services), goods, services, forgiveness for a financial penalty incurred by a consumer and/or an alert recipient for volitional and/or non-volitional participation in one or more actions and/or omissions that were the legal and/or proximate cause of an alert rule being satisfied and one or more account alerts being sent, and other such incentives likely to influence an alert recipient to respond to an account alert in a manner that is accurately, timely, and thorough.

By way of example, the transaction handlers 1202, issuers 1204, acquirers 1206, merchants 1210, and/or the account holders 1208, and/or one or more agents thereof, may have access to a data base of GUIDs 1250 that respectively correspond to a plurality account holders 1208.

By way of example, and not by way of limitation, the data base of GUIDs 1250 can have stored, for each GUID corresponding to a consumer: (i) one or more identifiers for respective prepaid accounts; (ii) one or more logical addresses; (iii) one or more identifiers for respective merchant(s); (iv) one or more identifiers for respective location(s); and (v) one or more identifiers for respective item(s) (e.g.; goods and/or services).

Whenever one of the GUIDs in the data base is used to conduct an activity that may have an effect on the corresponding account holder (a) 1208, an alert recipient will receive a corresponding account alert some time period after the occurrence of the activity. Each such party having access to database 1250 may receive an alert incident to an activity which may have involved any the issuers 1204, the acquirers 1206, the merchants 1210, and/or the account holders 1208. The activity may be, for example, a request to an issuer (i) 1204 to open a new account using the GUID (“account application”), a request to an issuer (i) 1204 to activate a newly issued prepaid account using the GUID, or a deposit to or withdrawal from the account associated with the GUID that is submitted to an issuer (i) 1204, where the deposit or withdrawal may or may not exceed a predetermined threshold.

In another implementation, a transaction handler (th) 1202 may receive an authorization request from an issuer (i) 1204 or an authorization response from an acquirer (q) 1206, or one or more agents thereof. The request or response may be for a transaction upon an account that is being conducted by an account user (au) 1208 with a merchant (m) 1210. The transaction handler (th) 1202 accesses database 1250 to see if the account corresponds to a GUID for a consumer, where GUIDs and corresponding accounts for consumers are stored in database 1250. If there is a match, and if any other criteria for an alert rule for the matching GUID are satisfied, then an alert recipient will be sent a corresponding account alert. In response, perhaps in exchange for an incentive to the consumer, the alert recipient uses a mobile computing apparatus to perform an interactive exchange of information with the transaction handler (th) 1202, or agent thereof, preferably within a predetermined time period after receipt of the account alert. The transaction handler (th) 1202, or agent thereof, can transmit notice through network 1212 or through an acquirer (q) 1206, on the basis of the exchanged information, to the merchant (m) 1210 that a fraudulent transaction is now being conducted. As such, a fraudulent transaction can be stopped while being conducted. Advantageously, since the transaction handlers 1202 may handle virtually all transactions in real time within the payment processing system 1200, the alert system disclosed herein can provide real time alerts for virtually all transactions that occur in real time.

In the foregoing implementation, upon receipt of notice of the activity by a party, or agent thereof, having access to the database 1250, an access will be made to the database 1250 to see if there is a match in the database 1250 to the GUID that was received with information about the activity. If there is a match, and if there is a satisfaction of a corresponding alert rule according to predetermined criteria, then an alert recipient will receive a corresponding account alert some time period after the occurrence of the activity.

The various steps or acts in a method or process may be performed by hardware executing software, and in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

1. Any method performed by hardware executing software to activate an issued prepaid account for which a Globally Unique IDentifier (GUID) for a consumer is offered to be associated, wherein the GUID matches an electronically stored said GUID having associated therewith a plurality of logical addresses, and wherein the prepaid account is activated only after an electronic response is received from each said logical address to which an electronic request sent, and wherein each said received electronic response includes information corresponding to an approval of the activation of the prepaid account so as to be associated with the stored said GUID.

2. The method as defined in claim 1, wherein the stored said GUID is one of a plurality of said GUID each of which having corresponding said logical addresses, and wherein the method further comprises, prior to activating the prepaid account, matching the GUID for the issued prepaid account against the stored plurality of said GUIDs.

3. The method as defined in claim 1, wherein each said logical address is selected from the group consisting of cellular telephone number, electronic mail (e-mail) address, facsimile number, file transport protocol address, Universal Resource Locator address (URL), a World Wide Web address, an Internet address, and combinations of the foregoing.

4. The method as defined in claim 1, wherein the stored said GUID is a type selected from the group consisting of a tax identification number for a business, a social security number, a passport identification number, a government issued identifier, a drivers license number, a biological metric identifier, and combinations of the foregoing.

5. A method comprising a plurality of steps each being performed by hardware executing software, wherein the steps include:
receiving a Globally Unique IDentifier (GUID);
accessing a network device storing for each of a plurality of consumers:
one said GUID uniquely identifying the consumer from other said consumers; and
a plurality of logical addresses, wherein:
an electronic request message can be sent for delivery to each said logical address; and
an electronic response message can be received in response to the electronic request message from each said logical address;
and
if the received GUID has a match in the GUIDs stored in the network device:
transmitting the electronic request message, for delivery to each said logical address corresponding to the matching said GUID, wherein the electronic request message includes a request to activate an issued and unfunded prepaid account;
upon receipt of the electronic response message from each said logical address corresponding to the matching said GUID, wherein the electronic response message includes information corresponding to an approval of the request to activate the issued and unfunded prepaid account, transmitting an approval to activate the issued and unfunded prepaid account so as to be associated with the received GUID.

6. The method as defined in claim 5, wherein:
each said logical address is selected from the group consisting of cellular telephone number, electronic mail (e-mail) address, facsimile number, file transport protocol address, Universal Resource Locator address (URL), a World Wide Web address, an Internet address, and combinations of the foregoing; and
each said GUID is a type selected from the group consisting of a tax identification number for a business, a social security number, a passport identification number, a government issued identifier, a drivers license number, a biological metric identifier, and combinations of the foregoing.

7. An non-transitory computer readable medium comprising instructions which, when executed by a computing apparatus, the computing apparatus performs the method defined in claim 5.

8. A method comprising a plurality of steps each being performed by hardware executing software, wherein the steps include:
receiving an identifier:
for an activated prepaid account; and
a currency amount to be funded into the activated prepaid account;
determining whether the currency account exceeds a predetermined threshold, if so, then;
accessing a network device storing for each of a plurality of consumers:
a Globally Unique IDentifier (GUID) uniquely identifying the consumer from other said consumers;
an identifier for one or more said activated prepaid accounts; and
a plurality of logical addresses, wherein:
an electronic request message can be sent for delivery to each said logical address; and
an electronic response message can be received in response to the electronic request message from each said logical address;
if the received identifier for the activated prepaid account has a corresponding said GUID stored in the network device:
transmitting the electronic request message, for delivery to each said logical address corresponding to the matching said GUID, wherein the electronic request message includes a request to fund the activated prepaid account in excess of the predetermined threshold;
upon receipt of the electronic response message from each said logical address corresponding to the matching said GUID, wherein the electronic response message includes information corresponding to an approval of the request to fund the activated prepaid account in excess of the predetermined threshold, transmitting an approval to fund the activated prepaid account with the currency amount.

9. The method as defined in claim 8, wherein:
each said logical address is selected from the group consisting of cellular telephone number, electronic mail (e-mail) address, facsimile number, file transport protocol address, Universal Resource Locator address (URL), a World Wide Web address, an Internet address, and combinations of the foregoing; and
each said GUID is a type selected from the group consisting of a tax identification number for a business, a social security number, a passport identification number, a government issued identifier, a drivers license number, a biological metric identifier, and combinations of the foregoing.

10. An non-transitory computer readable medium comprising instructions which, when executed by a computing apparatus, the computing apparatus performs the method defined in claim 8.

11. A method comprising a plurality of steps each being performed by hardware executing software, wherein the steps include:
receiving an identifier:
for an activated prepaid account;
a currency amount to be funded into the activated prepaid account;
determining whether the currency account exceeds a predetermined threshold, if so, then;
accessing a network device storing for each of a plurality of consumers:
a Globally Unique IDentifier (GUID) uniquely identifying the consumer from other said consumers;
an identifier for one or more said activated prepaid accounts; and
a logical address:
to which an electronic request message can be sent for delivery; and
from which an electronic response message can be received in response to the electronic request message;
and
if the received identifier for the activated prepaid account has a corresponding said GUID stored in the network device:
transmitting the electronic request message, for delivery to the logical address corresponding to the matching said GUID, wherein the electronic request message includes a request to fund the activated prepaid account in excess of the predetermined threshold;
and
upon receipt of the electronic response message from the logical address corresponding to the matching said GUID, wherein the electronic response message includes the matching said GUID, transmitting an approval to fund the activated prepaid account with the currency amount.

12. The method as defined in claim 11, wherein each said logical address is selected from the group consisting of cellular telephone number, electronic mail (e-mail) address, facsimile number, file transport protocol address, Universal Resource Locator address (URL), a World Wide Web address, an Internet address, and combinations of the foregoing;

13. The method as defined in claim 11, wherein each said GUID is a type selected from the group consisting of a tax identification number for a business, a social security number, a passport identification number, a government issued identifier, a drivers license number, a biological metric identifier, and combinations of the foregoing.

14. The method as defined in claim 11, wherein the step of determining of whether the currency account exceeds the predetermined threshold further comprises a determination that the currency amount, in addition to previously received other currency amounts within a predetermined time period, cumulatively exceeds the predetermined threshold.

15. The method as defined in claim 11, wherein the step of determining of whether the currency account exceeds the predetermined threshold further comprises a determination that the currency amount neither exceeds nor less than a specific currency amount by the predetermined threshold.

16. An non-transitory computer readable medium comprising instructions which, when executed by a computing apparatus, the computing apparatus performs the method defined in claim 11.

17. A method comprising a plurality of steps each being performed by hardware executing software, wherein the steps include:
receiving transaction data identifying an item being purchased from a merchant at a location in a transaction being conducted on an activated prepaid account;
accessing a network device storing for each of a plurality of consumers:
an identifier for each of one or more said activated prepaid accounts;
identifiers for one or more said items, one or more said merchants, and one of more said locations;
a Globally Unique IDentifier (GUID) uniquely identifying the consumer from other said consumers;
and
a logical address:
to which an electronic request message can be sent for delivery; and
from which an electronic response message can be received in response to the electronic request message;
if the activated prepaid account that is in the received transaction data has a match in the activated prepaid accounts stored in the network device; then
if the item, the merchant, or the location identified in the received transaction data has a match in corresponding any said identifier stored in the network device for the one or more said items, for the one or more said merchants, or for the one of more said locations, then:
transmitting the electronic request message, for delivery to the logical address corresponding to the GUID corresponding to the matching said activated prepaid account, wherein the electronic request message includes a request to approve the purchase;
and
upon receipt of the electronic response message from the logical address corresponding to the GUID corresponding to the matching said activated prepaid account, wherein the electronic response message includes the GUID corresponding to the matching said activated prepaid account, transmitting an approval of the purchase.

18. The method as defined in claim 17, wherein each said logical address is selected from the group consisting of a cellular telephone number, an electronic mail (e-mail) address, a facsimile number, a file transport protocol address, a Universal Resource Locator address (URL), a World Wide Web address, an Internet address, and combinations of the foregoing.

19. The method as defined in claim 17, wherein each said GUID is a type selected from the group consisting of a tax identification number for a business, a social security number, a passport identification number, a government issued identifier, a drivers license number, a biological metric identifier, and combinations of the foregoing.

20. An non-transitory computer readable medium comprising instructions which, when executed by a computing apparatus, the computing apparatus performs the method defined in claim 17.
